(19) United States
(12) Patent Application Publication
(10) Pub. No.: US 2025/0076614 A1
(43) Pub. Date: Mar. 6, 2025

(54) IMAGING LENS SYSTEM

(71) Applicant: Samsung Electro-Mechanics Co., Ltd., Suwon-si (KR)

(72) Inventors: Seong Il CHO, Suwon-si (KR); You Jin JEONG, Suwon-si (KR); Byung Hyun KIM, Suwon-si (KR); Geon Hwi PARK, Suwon-si (KR)

(73) Assignee: Samsung Electro-Mechanics Co., Ltd., Suwon-si (KR)

(21) Appl. No.: 18/665,131

(22) Filed: May 15, 2024

(30) Foreign Application Priority Data
Sep. 6, 2023 (KR) 10-2023-0118393

(51) Int. Cl. G02B 13/00; G02B 9/62

(52) U.S. Cl. CPC G02B 13/0045; G02B 9/62

(57) ABSTRACT

An imaging lens system is provided. The imaging lens system includes a first lens having refractive power, a second lens having refractive power, a third lens having a convex object-side surface, a fourth lens having refractive power, a fifth lens having refractive power, and a sixth lens having refractive power. The first lens to the sixth lens are sequentially arranged from an object side toward an imaging plane. The imaging lens system satisfies the conditional expressions TTL/f<1.0 and 0.9<f1/f4<1.4, where TTL is a distance from an object-side surface of the first lens to the imaging plane, f is a focal length of the imaging lens system, f1 is a focal length of the first lens, and f4 is a focal length of the fourth lens.

### CROSS-REFERENCE TO RELATED APPLICATIONS

This application claims the benefit under 35 USC § 119 (a) of Korean Patent Application No. 10-2023-0118393 filed on Sep. 6, 2023, in the Korean Intellectual Property Office, the entire disclosure of which is incorporated herein by reference for all purposes.

### BACKGROUND

### 1. Field

The following description relates to an imaging lens system.

### 2. Description of Related Art

Portable terminals may include a camera module. For example, the camera module may be mounted in a front-facing portion or a rear-facing portion of the portable terminal. As the capture of still images or as the recording of moving images using the portable terminal increase, there is demand for camera modules with high magnification and high performance (e.g., a low f number).

In order to implement a camera module with high magnification and high performance, an imaging lens system including a lens with a large effective diameter is desired. However, since an installation space for a camera module in the portable terminal may be significantly narrow, it may be difficult to arrange the above-described type of imaging lens system.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an imaging lens system includes a first lens having refractive power; a second lens having refractive power; a third lens having a convex object-side surface; a fourth lens having refractive power; a fifth lens having refractive power; and a sixth lens having refractive power, wherein the first lens to the sixth lens are sequentially arranged from an object side toward an imaging plane, and wherein the imaging lens system satisfies the following conditional expressions: TTL/f<1.0, and 0.9<f1/f4<1.4, where TTL is a distance from an object-side surface of the first lens to the imaging plane, f is a focal length of the imaging lens system, f1 is a focal length of the first lens, and f4 is a focal length of the fourth lens.

The first lens may have a convex object-side surface.

The second lens may have a concave image-side surface.

The fourth lens may have a convex object-side surface.

The fifth lens may have a concave object-side surface.

The imaging lens system may satisfy the following conditional expression: 2.0<TTL/BFL<3.0, where BFL is a distance from an image-side surface of a rearmost lens disposed closest to the imaging plane, to the imaging plane.

The imaging lens system may satisfy the following conditional expression: 0.42<ImgHT/BFL<0.60, where ImgHT is a height of the imaging plane, and BFL is a distance from an image-side surface of a rearmost lens disposed closest to the imaging plane, to the imaging plane.

In a general aspect, an imaging lens system includes a first lens having refractive power; a second lens having refractive power; a third lens having refractive power; a fourth lens having a convex image-side surface; a fifth lens having a concave object-side surface; and a sixth lens having refractive power, wherein the first lens to the sixth lens are sequentially arranged from an object side toward an imaging plane, wherein one or more of the first lens to the sixth lens are formed such that an effective radius (Xc) in a first direction, intersecting an optical axis, is different from an effective radius (Yc) in a second direction, intersecting the optical axis, and wherein the imaging lens system satisfies the following conditional expression: TTL/f<1.0, where TTL is a distance from an object-side surface of the first lens to the imaging plane, and f is a focal length of the imaging lens system.

The first lens may have a convex object-side surface.

The second lens may have a concave image-side surface.

The third lens may have a convex object-side surface.

The sixth lens may have a convex object-side surface.

The imaging lens system may satisfy the following conditional expression: 0.5<AR1<1.0, where AR1 is a ratio (Yc1/Xc1) of an effective radius (Yc1) in a short axis direction (the second direction) of the first lens and an effective radius (Xc1) in a long axis direction (the first direction) of the first lens.

The imaging lens system may satisfy the following conditional expression: 0< (D12+D23)/D34<0.5, where D12 is a distance from an image-side surface of the first lens to an object-side surface of the second lens, D23 is a distance from an image-side surface of the second lens to an object-side surface of the third lens, and D34 is a distance from an image-side surface of the third lens to an object-side surface of the fourth lens.

The imaging lens system may satisfy the following conditional expression: 0.3<Xc1/SumT<0.8, where Xc1 is an effective radius in a long axis direction (the first direction) of the first lens, and SumT is a sum of thicknesses of all lenses disposed between an object and the imaging plane.

The imaging lens system may satisfy the following conditional expression: 2.0<TTL/SumT)<3.0, where SumT is a sum of thicknesses of all lenses disposed between an object and the imaging plane.

In a general aspect, an imaging lens system includes a first lens having refractive power; a second lens having refractive power; a third lens having a convex object-side surface; a fourth lens having refractive power; a fifth lens having refractive power; and a sixth lens having refractive power, wherein the first lens to the sixth lens are sequentially arranged from an object side toward an imaging plane, and wherein the imaging lens system satisfies the following conditional expression: 0.20<D56/BFL<0.50, where D56 is a distance from an image-side surface of the fifth lens to an object-side surface of the sixth lens and BFL is a distance from an image-side surface of the sixth lens to the imaging plane.

The imaging lens system may further include a seventh lens disposed on an image side of the sixth lens.

The seventh lens may have a convex object-side surface in a paraxial region, and a concave image-side surface in a paraxial region.

Other features and aspects will be apparent from the following detailed description, the drawings, and the claims.

### BRIEF DESCRIPTION OF DRAWINGS

FIG. 1 illustrates a configuration diagram of an example imaging lens system, in accordance with a first example.

FIG. 2 illustrates an aberration curve of the example imaging lens system illustrated in FIG. 1.

FIG. 3 illustrates a configuration diagram of an example imaging lens system, in accordance with a second example.

FIG. 4 illustrates an aberration curve of the example imaging lens system illustrated in FIG. 3.

FIG. 5 illustrates a configuration diagram of an example imaging lens system, in accordance with a third example.

FIG. 6 illustrates an aberration curve of the example imaging lens system illustrated in FIG. 5.

FIG. 7 illustrates a configuration diagram of an example imaging lens system, in accordance with a fourth example.

FIG. 8 illustrates an aberration curve of the example imaging lens system illustrated in FIG. 7.

FIG. 9 illustrates a configuration diagram of an example imaging lens system, in accordance with a fifth example.

FIG. 10 illustrates an aberration curve of the example imaging lens system illustrated in FIG. 9.

FIG. 11 illustrates a configuration diagram of an example imaging lens system, in accordance with a sixth example.

FIG. 12 illustrates an aberration curve of the example imaging lens system illustrated in FIG. 11.

FIG. 13 illustrates a configuration diagram of an example imaging lens system, in accordance with a seventh example.

FIG. 14 illustrates an aberration curve of the example imaging lens system illustrated in FIG. 13.

FIG. 15 illustrates a configuration diagram of an example imaging lens system, in accordance with an eighth example.

FIG. 16 illustrates an aberration curve of the example imaging lens system illustrated in FIG. 15.

FIG. 17 illustrates a configuration diagram of an example imaging lens system, in accordance with a ninth example.

FIG. 18 illustrates an aberration curve of the example imaging lens system illustrated in FIG. 17.

FIG. 19 illustrates a configuration diagram of an example imaging lens system, in accordance with a tenth example.

FIG. 20 illustrates an aberration curve of the example imaging lens system illustrated in FIG. 19.

FIG. 21 illustrates a configuration diagram of an example imaging lens system, in accordance with an eleventh example.

FIG. 22 illustrates an aberration curve of the example imaging lens system illustrated in FIG. 21.

FIG. 23 illustrates a configuration diagram of an example imaging lens system, in accordance with a twelfth example.

FIG. 24 illustrates an aberration curve of the example imaging lens system illustrated in FIG. 23.

FIG. 25 illustrates a configuration diagram of an example imaging lens system, in accordance with a thirteenth example.

FIG. 26 illustrates an aberration curve of the example imaging lens system illustrated in FIG. 25.

FIG. 27 illustrates a plan view of first to third lenses, in accordance with one or more examples.

FIG. 28 illustrates modified examples of the example imaging lens system, in accordance with the first to thirteenth examples.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

In the drawings attached to this specification, the thickness, size, and shape of the lens are somewhat exaggerated for explanation, and a spherical or aspherical shape of the lens is only shown as an example and is not limited to this shape.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

In an example, the imaging lens system may be configured to realize high resolution even in a low illuminance environment.

One or more examples may provide an imaging lens system configured to implement a camera module with high magnification and high performance.

In the one or more examples, a first lens refers to a lens most adjacent to an object (or a subject), and a sixth lens or a seventh lens refers to a lens most adjacent to an imaging plane (or an image sensor). In the one or more examples, units of a radius of curvature, a thickness, TTL (a distance from an object-side surface of the first lens to the imaging plane), Y (a height of the imaging plane), and a focal length are indicated in millimeters (mm).

A thickness of a lens, a gap between lenses, and a TTL refers to a distance of a lens along an optical axis. Also, in the descriptions of a shape of a lens, a configuration in which one surface is convex indicates that a paraxial region of the surface is convex, and a configuration in which one surface is concave indicates that a paraxial region of the surface is concave. Thus, even when it is described that one surface of a lens is convex, an edge of the lens may be concave. Similarly, even when it is described that one surface of a lens is concave, an edge of the lens may be convex.

An imaging lens system according to a first aspect may include six or seven lenses. For example, the imaging lens system may include a first lens, a second lens, a third lens, a fourth lens, a fifth lens, and a sixth lens, sequentially arranged from an object side toward an imaging plane. As another example, the imaging lens system may include a first lens, a second lens, a third lens, a fourth lens, a fifth lens, a sixth lens, and a seventh lens, sequentially arranged from an object side toward an imaging plane. The imaging lens system according to the first aspect may include a lens having a convex object-side surface. For example, in the imaging lens system according to the first aspect, the third lens may have a convex object-side surface. The imaging lens system according to the first aspect may satisfy a unique conditional expression. For example, the imaging lens system according to the first aspect may satisfy all of the following conditional expressions:

TTL/f<1.0

0.9<f1/f4<1.4

In the above conditional expressions, TTL is a distance from an object-side surface of the first lens to an imaging plane, f is a focal length of the imaging lens system, f1 is a focal length of the first lens, and f4 is a focal length of the fourth lens.

An imaging lens system according to a second aspect may include a total of six or seven lenses. For example, the imaging lens system may include a first lens, a second lens, a third lens, a fourth lens, a fifth lens, and a sixth lens, sequentially arranged from an object side toward an imaging plane. As another example, the imaging lens system may include a first lens, a second lens, a third lens, a fourth lens, a fifth lens, a sixth lens, and a seventh lens, sequentially arranged from an object side toward an imaging plane. The imaging lens system according to the second aspect may include a lens having a convex image-side surface. For example, in the imaging lens system according to the second aspect, the fourth lens may have a convex image-side surface. The imaging lens system according to the second aspect may include a lens having a concave object-side surface. For example, in the imaging lens system according to the second aspect, the fifth lens may have a concave object-side surface. The imaging lens system according to the second aspect may include one or more lenses configured such that an effective radius (Xc) in a first direction, intersecting an optical axis, is different from an effective radius (Yc) in the second direction, intersecting the optical axis. For example, in the imaging lens system according to the second aspect, Xc and Yc in one or more of the first to sixth lenses may be formed to have different lengths. The imaging lens system according to the second aspect may satisfy a unique conditional expression. For example, the imaging lens system according to the second aspect may satisfy the condition TTL/f<1.0.

An imaging lens system according to a third aspect may include first to sixth lenses or first to seventh lenses, sequentially arranged from an object side toward an imaging plane, and may satisfy one or more of the following conditional expressions:

0.5<AR1<1.0

0<(D12+D23)/D34<0.8

0.3<Xc1/SumT<0.8

2.0<TTL/SumT<3.0

In the above conditional expression, AR1 is a ratio (Yc1/Xc1) of an effective radius (Yc1) in a short axis direction (on an object-side surface) of the first lens and an effective radius (Xc1) in a long axis direction (on an object-side surface) of the first lens, D12 is a distance from an image-side surface of the first lens to an object-side surface of the second lens, D23 is a distance from an image-side surface of the second lens to an object-side surface of the third lens, D34 is a distance from an image-side surface of the third lens to an object-side surface of the fourth lens, and SumT is a sum of thicknesses of all lenses (for example, the first to sixth lenses or the first to seventh lenses) disposed between an object and the imaging plane.

An imaging lens system according to a fourth aspect may include first to sixth lenses or first to seventh lenses, sequentially arranged from an object side toward an imaging plane, and may include one or more lenses configured such that an effective radius (Xc) in a first direction, intersecting an optical axis, is different from an effective radius (Yc) in the second direction, intersecting the optical axis. For example, in the imaging lens system according to the fourth aspect, Xc and Yc in one or more of the first to third lenses may be formed to have different lengths. Additionally, the imaging lens system according to the fourth aspect may satisfy one or more of the following conditional expressions:

0.5<AR1<0.8

0.6<AR2<0.9

0.7<AR3<1.0

$$1. < AR 1 / AR 2 < 1.2$$

$$1.2 < AR 1 / AR 3 < 1.3$$

In the above conditional expression, AR2 is a ratio (Yc2/Xc2) of an effective radius (Yc2) in a short axis direction of the second lens and an effective radius (Xc2) in a long axis direction of the second lens, and AR3 is a ratio (Yc3/Xc3) of an effective radius (Yc3) in a short axis direction of the third lens and an effective radius (Xc3) in a long axis direction of the third lens.

An imaging lens system according to a fifth aspect may include first to sixth lenses or first to seventh lenses, sequentially arranged from an object side toward an imaging plane, and may satisfy one or more of the following conditional expressions:

$$TTL / f < 1.$$

$$2. < TTL / BFL < 3.$$

$$0.5 < ER 1 / BFL < 0.80$$

$$0.2 < D 56 / BFL < 0.50$$

$$2. < f / BFL < 3.$$

$$- 1.4 \; 0 < f 5 / BFL < - 0.70$$

$$0.42 < ImgHT / BFL < 0.60$$

In the above conditional expression, ER1 is a maximum effective radius of the first lens, BFL is a distance from an image-side surface of the sixth lens to the imaging plane, D56 is a distance from an image-side surface of the fifth lens to an object-side surface of the sixth lens, f5 is a focal length of the fifth lens, and ImgHT is a height of the imaging plane.

An imaging lens system according to a sixth aspect may include first to sixth lenses or first to seventh lenses, sequentially arranged from an object side toward an imaging plane, and may satisfy one or more of the following conditional expressions:

$$0.9 < f 1 / f 4 < 1 \text{.40}$$

$$- 0.8 \; 0 < f 2 / f 3 < - 0.40$$

$$- 2. < f 4 / f 5 < - 1.$$

$$0.9 < ( f 2 + f 3 ) / ( f 4 + f 5 ) < 4.$$

$$0.8 < R 1 / R 10 < 1.40$$

$$0.8 < ( R 1 + R 4 ) / ( R 5 + R 10 ) < 1.20$$

$$0.8 < T 1 / ( T 2 + T 3 ) < 1.32$$

$$0.7 < T 4 / ( T 5 + T 6 ) < 1.60$$

In the above conditional expression, f1 is a focal length of the first lens, f2 is a focal length of the second lens, f3 is a focal length of the third lens, f4 is a focal length of the fourth lens, R1 is a radius of curvature of an object-side surface of the first lens, R4 is a radius of curvature of an image-side surface of the second lens, R5 is a radius of curvature of an object-side surface of the third lens, R10 is a radius of curvature of an image-side surface of the fifth lens, T1 is a thickness of the first lens, T2 is a thickness of the second lens, T3 is a thickness of the third lens, T4 is a thickness of the fourth lens, T5 is a thickness of the fifth lens, and T6 is a thickness of the sixth lens.

An imaging lens system according to a seventh aspect may include at least one characteristic according to the first to fourth aspects, and may be configured to further include an optical path conversion device. For example, the imaging lens system according to the seventh aspect may further include a prism disposed on an object-side surface of the first lens along with a characteristic according to the first aspect. As another example, the imaging lens system according to the seventh aspect may further include a prism disposed on the object-side surface of the first lens along with a characteristic according to the second aspect. For reference, a placement position of the prism (i.e., optical path conversion means) is not limited to the object-side surface of the first lens, it is also possible to be disposed between the first lens and the second lens or between a rearmost lens (sixth or seventh lens) and the imaging plane.

An imaging lens system according to the one or more examples may include at least one lens having the following characteristics, as needed. For example, the imaging lens system according to the first aspect may include at least one of the first to seventh lenses according to the following characteristics. As another example, the imaging lens system according to the second to seventh aspects may include at least one of the first to seventh lenses according to the following characteristics. However, the imaging lens system according to the above-described form may not necessarily include a lens according to the following characteristics. Below, characteristics of the first to seventh lenses will be described.

The first lens may have refractive power. For example, the first lens may have positive refractive power. The first lens may have a convex side surface. For example, the first lens may have a convex object-side surface. The first lens may include an aspherical surface. For example, both surfaces of the first lens may be aspherical. The first lens may be formed of a material having high light transmittance and excellent processability. For example, the first lens may be formed of a plastic or a glass material. The first lens may be configured to have a high refractive index. For example, the refractive index of the first lens may be less than 1.6. The first lens may have a predetermined Abbe number. For example, an Abbe number of the first lens may be 54 or greater.

The second lens may have refractive power. For example, the second lens may have negative refractive power. The second lens may have a concave surface. For example, the second lens may have a concave image-side surface. The second lens may include an aspherical surface. For example, both surfaces of the second lens may be aspherical. The second lens may be formed of a material having high light transmittance and excellent processability. For example, the second lens may be formed of a plastic or a glass material. The second lens may be configured to have a refractive index, greater than the refractive index of the first lens. For example, the refractive index of the second lens may be more than 1.6. The second lens may have a predetermined Abbe number. For example, an Abbe number of the second lens may be 20 or more. As another example, an Abbe number of the second lens may be greater than 20 but less than 30.

The third lens may have refractive power. For example, the third lens may have positive refractive power. The third lens may have a convex surface. For example, the third lens may have a convex object-side surface. The third lens may include an aspherical surface. For example, both surfaces of the third lens may be aspherical. The third lens may be formed of a material having high light transmittance and excellent processability. For example, the third lens may be formed of a plastic material. The third lens may be configured to have a refractive index, less than the refractive index of the second lens. For example, the refractive index of the third lens may be less than 1.6. The third lens may have a predetermined Abbe number. For example, an Abbe number of the third lens may be greater than 50. As another example, an Abbe number of the third lens may be greater than 50 but less than 60.

The fourth lens may have refractive power. For example, the fourth lens may have positive refractive power. The fourth lens may have a convex surface. For example, the fourth lens may have a convex object-side surface. As another example, the fourth lens may have a convex image-side surface. The fourth lens may include an aspherical surface. For example, both surfaces of the fourth lens may be aspherical. The fourth lens may be formed of a material having high light transmittance and excellent processability. The fourth lens may be formed of a plastic material. The fourth lens may be configured to have a refractive index, greater than the refractive index of the first lens. For example, the refractive index of the fourth lens may be greater than 1.6. The fourth lens may have a predetermined Abbe number. For example, an Abbe number of the fourth lens may be less than 30.

The fifth lens may have refractive power. For example, the fifth lens may have negative refractive power. The fifth lens may have a concave surface. For example, the fifth lens may have a concave object-side surface. The fifth lens may include an aspherical surface. For example, at least one surface of the fifth lens may be aspherical. The fifth lens may be formed of a material having high light transmittance and excellent processability. The fifth lens may be formed of a plastic material. The fifth lens may be configured to have a refractive index, greater than the refractive index of the first lens. For example, the refractive index of the fifth lens may be greater than 1.6. The fifth lens may have a predetermined Abbe number. For example, an Abbe number of the fifth lens may be less than 30.

The sixth lens may have refractive power. For example, the sixth lens may have positive or negative refractive power. The sixth lens may have a convex surface. For example, the sixth lens may have a convex image-side surface or a convex object-side surface. The sixth lens may include an aspherical surface. For example, at least one surface of the sixth lens may be aspherical. The sixth lens may be formed of a material having high light transmittance and excellent processability. For example, the sixth lens may be formed of a plastic material. The sixth lens may be configured to have a predetermined refractive index. For example, the refractive index of the sixth lens may be less than 1.6. The sixth lens may have a predetermined Abbe number. For example, an Abbe number of the sixth lens may be greater than 50.

The seventh lens may have refractive power. For example, the seventh lens may have negative refractive power. The seventh lens may have a convex surface. For example, the seventh lens may have a convex object-side surface. The seventh lens may include an aspherical surface. For example, at least one surface of the seventh lens may be aspherical. The seventh lens may include an inflection point. For example, the inflection point may be formed on at least one of the object-side surface or the image-side surface of the seventh lens. The seventh lens may be formed of a material having high light transmittance and excellent processability. For example, the seventh lens may be formed of a plastic material. The seventh lens may be configured to have a predetermined refractive index. For example, the refractive index of the seventh lens may be less than 1.6. The seventh lens may have a predetermined Abbe number. For example, an Abbe number of the seventh lens may be greater than 50.

As described above, the first to seventh lenses may include a spherical surface or an aspherical surface. When the first to seventh lenses include an aspheric surface, the aspherical surface of the corresponding lens may be expressed by Equation 1.

$$Equation 1$$

$$Z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + {Hr}^{18} + {Jr}^{20} …$$

In Equation 1, c is the reciprocal of a radius of curvature of a corresponding lens, k is a conic constant, r is a distance from a certain point on an aspherical surface to an optical axis, A to H and J are aspherical surface constants, and Z (or SAG) is a height in an optical axis direction from a certain point on the aspherical surface to a vertex of the corresponding aspherical surface.

An imaging lens system according to the above-described embodiment or the above-described form may further include a filter. As an example, the filter may be disposed between the sixth or seventh lens and the imaging plane. The filter may be configured to block light of specific wavelengths. For reference, the filter described in the one or more examples is configured to block infrared rays, but the wavelength of light blocked through the filter is not limited to infrared rays.

Hereinafter, specific embodiments will be described in detail based on the attached illustration drawings.

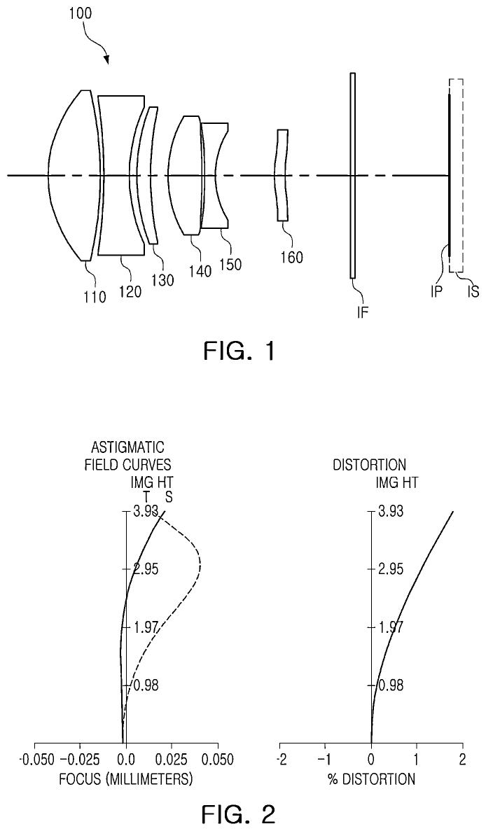

First, an imaging lens system 100 according to a first example of the one or more embodiments will be described with reference to FIG. 1.

The imaging lens system 100 may include a plurality of lens groups. For example, the imaging lens system 100 may include a first lens 110, a second lens 120, a third lens 130, a fourth lens 140, a fifth lens 150, and a sixth lens 160, sequentially arranged from an object side toward an imaging plane.

The first lens 110 may have positive refractive power, and may have a convex object-side surface and a convex image-side surface. The second lens 120 may have negative refractive power, and may have a concave object-side surface and a concave image-side surface. The third lens 130 may have positive refractive power, and may have a convex object-side surface and a concave image-side surface. The fourth lens 140 may have positive refractive power, and may have a convex object-side surface and a convex image-side surface. The fifth lens 150 may have negative refractive power, and may have a concave object-side surface and a concave image-side surface. The sixth lens 160 may have negative refractive power, and may have a convex object-side surface and a concave image-side surface.

The imaging lens system 100 may further include a filter IF and an imaging plane IP. The imaging plane IP may be formed on an image sensor IS, and the filter IF may be disposed between the sixth lens 160 and the imaging plane IP.

The imaging lens system 100 configured as above exhibits aberration characteristics as illustrated in FIG. 2. Tables 1 and 2 below illustrate lens characteristics and aspherical values of the imaging lens system according to the present example.

TABLE 1

| Surface | | Curvature | Thickness/ | Refractive | Abbe | Effective | Effective |
|---|---|---|---|---|---|---|---|
| No. | Component | Radius | Distance | Index | No. | Radius | Radius |
| S1 | 1st Lens | 6.089 | 2.400 | 1.535 | 55.74 | 4.150 | 3.225 |
| S2 | | −17.719 | 0.100 | | | 4.044 | 3.225 |
| S3 | 2nd Lens | −55.261 | 1.251 | 1.639 | 23.49 | 3.875 | 3.225 |
| S4 | | 7.182 | 0.368 | | | 3.363 | 3.225 |
| S5 | 3rd Lens | 11.674 | 0.569 | 1.544 | 55.99 | 3.324 | 3.225 |
| S6 | | 18.123 | 0.834 | | | 3.220 | 3.220 |
| S7 | 4th Lens | 6.301 | 1.554 | 1.661 | 20.38 | 2.896 | 2.896 |
| S8 | | −30.500 | 0.130 | | | 2.612 | 2.612 |
| S9 | 5th Lens | −16.499 | 0.500 | 1.614 | 25.94 | 2.563 | 2.563 |
| S10 | | 4.577 | 2.696 | | | 2.150 | 2.150 |
| S11 | 6th Lens | 5.589 | 0.500 | 1.567 | 37.40 | 2.200 | 2.200 |
| S12 | | 6.713 | 3.000 | | | 2.200 | 2.350 |
| S13 | Filter | Infinity | 0.210 | 1.518 | 64.17 | 5.000 | 5.000 |
| S14 | | Infinity | 4.336 | | | 5.000 | 5.000 |
| S15 | Imaging | Infinity | 0.002 | | | 3.947 | 3.947 |
| | plane | | | | | | |

TABLE 2

| Surface | | | | | | |
|---|---|---|---|---|---|---|
| No. | S1 | S2 | S3 | S4 | S5 | S6 |
| K | −5.681E−01 | −1.514E+01 | 5.529E+01 | −3.132E+00 | 0.000E+00 | 0.000E+00 |
| A | 9.784E−05 | 6.099E−05 | −6.115E−04 | −5.223E−04 | 5.391E−05 | 2.312E−05 |
| B | 4.624E−06 | 5.975E−06 | 3.337E−05 | 2.804E−05 | −1.792E−06 | 7.859E−06 |
| C | 1.163E−07 | −4.125E−07 | −7.799E−07 | −2.353E−07 | −7.286E−07 | 1.375E−06 |
| D | −1.017E−09 | −2.049E−08 | 1.404E−10 | −2.718E−08 | 4.534E−08 | 5.514E−08 |
| E | −1.723E−09 | −9.900E−10 | −1.917E−09 | 6.958E−09 | 1.156E−08 | −1.899E−09 |
| F | 3.903E−12 | −2.816E−11 | −1.670E−11 | 5.895E−11 | 1.654E−09 | 1.136E−09 |
| G | 3.039E−12 | 4.776E−12 | −8.793E−13 | −8.184E−11 | 0.000E+00 | 0.000E+00 |
| H | 1.168E−13 | −2.801E−14 | −1.528E−14 | −6.549E−12 | 0.000E+00 | 0.000E+00 |
| J | −1.832E−14 | −3.536E−15 | 1.946E−14 | 7.300E−13 | 0.000E+00 | 0.000E+00 |
| L | 0 | 0 | 0 | 0 | 0 | 0 |
| M | 0 | 0 | 0 | 0 | 0 | 0 |
| N | 0 | 0 | 0 | 0 | 0 | 0 |
| O | 0 | 0 | 0 | 0 | 0 | 0 |
| P | 0 | 0 | 0 | 0 | 0 | 0 |

| Surface | | | | | | |
|---|---|---|---|---|---|---|
| No. | S7 | S8 | S9 | S10 | S11 | S12 |
| K | −1.223E+00 | 3.188E+01 | −4.068E+01 | 6.638E−01 | −1.066E+01 | −1.638E+01 |
| A | −2.902E−04 | 4.290E−04 | 4.397E−04 | −1.208E−03 | −4.806E−03 | −5.180E−03 |
| B | 7.598E−05 | −1.220E−06 | 1.757E−05 | −3.337E−04 | −9.432E−04 | −8.872E−04 |
| C | 5.961E−06 | 7.237E−06 | −3.296E−06 | 8.053E−04 | 1.089E−04 | 1.303E−04 |
| D | 2.176E−08 | 1.285E−06 | −1.739E−06 | −5.911E−04 | −3.992E−06 | −1.633E−05 |
| E | 5.310E−08 | 5.485E−08 | −3.287E−08 | 2.636E−04 | −1.243E−06 | 1.097E−06 |
| F | 5.427E−09 | −6.027E−08 | 5.003E−09 | −7.417E−05 | 2.197E−07 | 1.127E−07 |
| G | −7.820E−10 | 5.727E−10 | −2.751E−09 | 1.279E−05 | −3.398E−08 | −1.229E−08 |
| H | −1.510E−10 | 0.000E+00 | 0.000E+00 | −1.237E−06 | 1.886E−09 | −6.299E−09 |
| J | 1.000E−11 | 0.000E+00 | 0.000E+00 | 5.101E−08 | −1.557E−10 | 6.081E−10 |
| L | 0 | 0 | 0 | 0 | 0 | 0 |
| M | 0 | 0 | 0 | 0 | 0 | 0 |
| N | 0 | 0 | 0 | 0 | 0 | 0 |
| O | 0 | 0 | 0 | 0 | 0 | 0 |
| P | 0 | 0 | 0 | 0 | 0 | 0 |

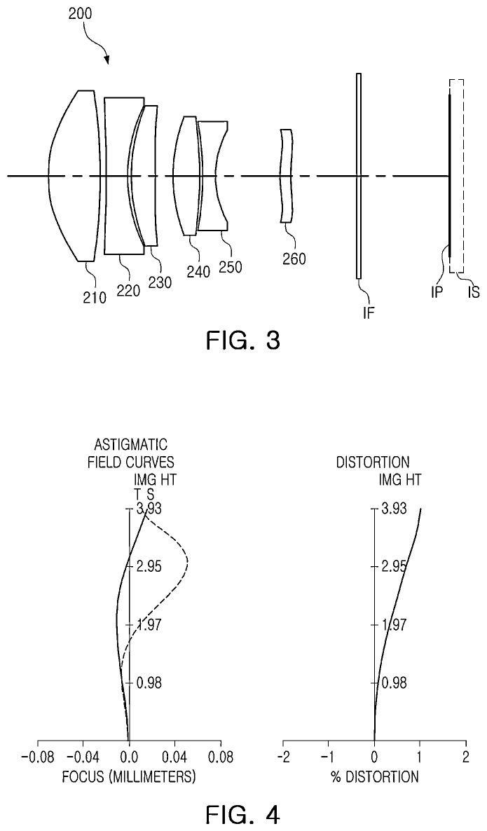

An imaging lens system 200 according to a second example of the one or more embodiments will be described with reference to FIG. 3.

The imaging lens system 200 may include a plurality of lenses. For example, the imaging lens system 200 may include a first lens 210, a second lens 220, a third lens 230, a fourth lens 240, a fifth lens 250, and a sixth lens 260, sequentially arranged from an object side toward an imaging plane.

The first lens 210 may have positive refractive power, and may have a convex object-side surface and a convex image-side surface. The second lens 220 may have negative refractive power, and may have a concave object-side surface and a concave image-side surface. The third lens 230 may have positive refractive power, and may have a convex object-side surface and a concave image-side surface. The fourth lens 240 may have positive refractive power, and may have a convex object-side surface and a convex image-side surface. The fifth lens 250 may have negative refractive power, and may have a concave object-side surface and a concave image-side surface. The sixth lens 260 may have positive refractive power, and may have a convex object-side surface and a concave image-side surface.

The imaging lens system 200 may further include a filter IF and an imaging plane IP. The imaging plane IP may be formed on an image sensor IS, and the filter IF may be disposed between the sixth lens 260 and the imaging plane IP.

The imaging lens system 200 configured as above exhibits aberration characteristics as illustrated in FIG. 4. Tables 3 and 4 below illustrate lens characteristics and aspherical values of the imaging lens system according to the present example.

TABLE 3

| Surface | | Curvature | Thickness/ | Refractive | Abbe | Effective | Effective |
|---|---|---|---|---|---|---|---|
| No. | Component | Radius | Distance | Index | No. | Radius (Xc) | Radius (Yc) |
| S1 | 1st Lens | 6.395 | 2.400 | 1.535 | 55.70 | 4.150 | 3.225 |
| S2 | | −24.460 | 0.233 | | | 4.002 | 3.225 |
| S3 | 2nd Lens | −445.958 | 1.028 | 1.639 | 23.50 | 3.811 | 3.225 |
| S4 | | 7.373 | 0.157 | | | 3.417 | 3.225 |
| S5 | 3rd Lens | 11.838 | 1.098 | 1.544 | 56.00 | 3.416 | 3.225 |
| S6 | | 131.193 | 0.787 | | | 3.274 | 3.225 |
| S7 | 4th Lens | 8.844 | 1.238 | 1.671 | 19.20 | 2.892 | 2.892 |
| S8 | | −24.801 | 0.118 | | | 2.698 | 2.698 |
| S9 | 5th Lens | −16.097 | 0.591 | 1.614 | 25.90 | 2.642 | 2.642 |
| S10 | | 4.840 | 2.976 | | | 2.250 | 2.250 |
| S11 | 6th Lens | 6.355 | 0.500 | 1.671 | 19.20 | 2.200 | 2.200 |
| S12 | | 7.208 | 3.000 | | | 2.250 | 2.250 |
| S13 | Filter | Infinity | 0.210 | 1.518 | 64.17 | 5.000 | 5.000 |
| S14 | | Infinity | 4.113 | | | 5.000 | 5.000 |
| S15 | Imaging | Infinity | 0.001 | | | 3.933 | 3.933 |
| | plane | | | | | | |

TABLE 4

| Surface | | | | | | |
|---|---|---|---|---|---|---|
| No. | S1 | S2 | S3 | S4 | S5 | S6 |
| K | −7.030E−01 | −2.309E+01 | 8.000E+01 | −2.670E+00 | 0.000E+00 | 0.000E+00 |
| A | 4.609E−06 | 1.114E−04 | −5.990E−04 | −4.347E−04 | 1.407E−04 | −4.396E−05 |
| B | 1.744E−06 | 6.598E−06 | 3.667E−05 | 3.148E−05 | 8.001E−06 | 2.960E−06 |
| C | −8.929E−08 | −3.711E−07 | −5.108E−07 | −5.559E−08 | −4.733E−07 | 1.634E−06 |
| D | −7.045E−09 | −1.858E−08 | 1.624E−08 | −2.100E−08 | 5.598E−08 | 8.564E−08 |
| E | −1.845E−09 | −8.060E−10 | −1.657E−09 | 9.672E−09 | 1.042E−08 | −1.107E−10 |
| F | −2.906E−12 | −1.121E−11 | −4.399E−11 | 4.505E−10 | 1.677E−09 | 3.737E−10 |
| G | 2.227E−12 | 5.255E−12 | −4.467E−12 | −4.249E−11 | 0.000E+00 | 0.000E+00 |
| H | 1.327E−13 | −6.533E−14 | −1.769E−13 | −5.883E−12 | 0.000E+00 | 0.000E+00 |
| J | −8.505E−15 | −5.806E−15 | 2.187E−14 | 4.911E−13 | 0.000E+00 | 0.000E+00 |
| L | 0 | 0 | 0 | 0 | 0 | 0 |
| M | 0 | 0 | 0 | 0 | 0 | 0 |
| N | 0 | 0 | 0 | 0 | 0 | 0 |
| O | 0 | 0 | 0 | 0 | 0 | 0 |
| P | 0 | 0 | 0 | 0 | 0 | 0 |

| Surface | | | | | | |
|---|---|---|---|---|---|---|
| No. | S7 | S8 | S9 | S10 | S11 | S12 |
| K | −1.710E+00 | 2.602E+01 | −3.714E+01 | 7.133E−01 | −1.339E+01 | −2.035E+01 |
| A | −4.081E−04 | 4.190E−04 | 3.969E−04 | −1.140E−03 | −6.140E−03 | −6.299E−03 |
| B | 6.741E−05 | −5.372E−06 | 1.469E−05 | −3.472E−04 | −1.123E−03 | −1.012E−03 |
| C | 3.854E−06 | 6.295E−06 | 1.824E−06 | 7.950E−04 | 1.310E−04 | 1.433E−04 |
| D | −2.586E−08 | 9.974E−07 | −9.465E−07 | −5.894E−04 | −1.119E−05 | −2.028E−05 |
| E | 5.795E−08 | 1.560E−07 | 7.883E−08 | 2.636E−04 | −8.948E−07 | 1.445E−06 |
| F | 3.961E−09 | −5.435E−08 | −4.108E−09 | −7.417E−05 | 2.197E−07 | 1.127E−07 |
| G | −9.010E−10 | 7.175E−10 | −3.364E−09 | 1.279E−05 | −3.398E−08 | −1.229E−08 |
| H | −1.366E−10 | 0.000E+00 | 0.000E+00 | −1.237E−06 | 1.886E−09 | −6.299E−09 |
| J | 1.210E−11 | 0.000E+00 | 0.000E+00 | 5.101E−08 | −1.557E−10 | 6.081E−10 |
| L | 0 | 0 | 0 | 0 | 0 | 0 |
| M | 0 | 0 | 0 | 0 | 0 | 0 |
| N | 0 | 0 | 0 | 0 | 0 | 0 |
| O | 0 | 0 | 0 | 0 | 0 | 0 |
| P | 0 | 0 | 0 | 0 | 0 | 0 |

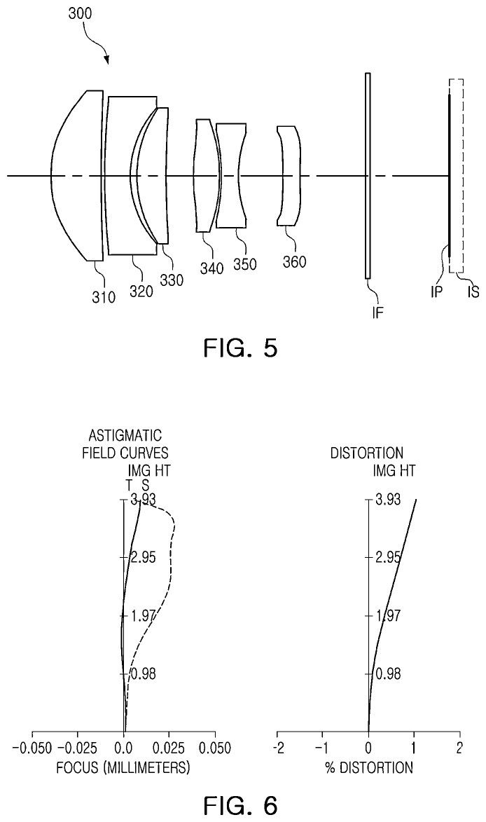

An imaging lens system 300 according to a third example of the one or more embodiments will be described with reference to FIG. 5.

The imaging lens system 300 may include a plurality of lens groups. For example, the imaging lens system 300 may include a first lens 310, a second lens 320, a third lens 330, a fourth lens 340, a fifth lens 350, and a sixth lens 360, sequentially arranged from an object side toward an imaging plane.

The first lens 310 may have positive refractive power, and may have a convex object-side surface and a concave image-side surface. The second lens 320 may have negative refractive power, and may have a convex object-side surface and a concave image-side surface. The third lens 330 may have positive refractive power, and may have a convex object-side surface and a concave image-side surface. The fourth lens 340 may have positive refractive power, and may have a convex object-side surface and a convex image-side surface. The fifth lens 350 may have negative refractive power, and may have a concave object-side surface and a concave image-side surface. The sixth lens 360 may have negative refractive power, and may have a convex object-side surface and a concave image-side surface.

The imaging lens system 300 may further include a filter IF and an imaging plane IP. The imaging plane IP may be formed on an image sensor IS, and the filter IF may be disposed between the sixth lens 360 and the imaging plane IP.

The imaging lens system 300 configured as above exhibits aberration characteristics as illustrated in FIG. 6. Tables 5 and 6 below illustrate lens characteristics and aspherical values of the imaging lens system according to the present example.

TABLE 5

| Surface | | Curvature | Thickness/ | Refractive | Abbe | Effective | Effective |
|---|---|---|---|---|---|---|---|
| No. | Component | Radius | Distance | Index | No. | Radius (Xc) | Radius (Yc) |
| S1 | 1st Lens | 5.656 | 2.297 | 1.535 | 55.70 | 4.150 | 3.225 |
| S2 | | 48.701 | 0.187 | | | 3.957 | 3.225 |
| S3 | 2nd Lens | 29.027 | 1.166 | 1.614 | 25.90 | 3.858 | 3.225 |
| S4 | | 4.564 | 0.264 | | | 3.306 | 3.225 |
| S5 | 3rd Lens | 5.522 | 1.400 | 1.544 | 56.00 | 3.304 | 3.225 |
| S6 | | 34.676 | 1.241 | | | 3.191 | 3.225 |
| S7 | 4th Lens | 11.964 | 1.186 | 1.671 | 19.20 | 2.747 | 2.747 |
| S8 | | −10.678 | 0.081 | | | 2.707 | 2.707 |
| S9 | 5th Lens | −9.568 | 0.774 | 1.614 | 25.90 | 2.546 | 2.546 |
| S10 | | 6.675 | 2.060 | | | 2.100 | 2.100 |
| S11 | 6th Lens | 27.232 | 0.797 | 1.544 | 56.00 | 2.150 | 2.150 |
| S12 | | 19.508 | 3.000 | | | 2.411 | 2.411 |
| S13 | Filter | Infinity | 0.210 | 1.518 | 64.17 | 5.000 | 5.000 |
| S14 | | Infinity | 3.640 | | | 5.000 | 5.000 |
| S15 | Imaging | Infinity | −0.001 | | | 3.938 | 3.938 |
| | plane | | | | | | |

TABLE 6

| Surface | | | | | | |
|---|---|---|---|---|---|---|
| No. | S1 | S2 | S3 | S4 | S5 | S6 |
| K | −5.069E−01 | 0.000E+00 | 0.000E+00 | −3.798E−01 | −2.709E−02 | −2.850E+00 |
| A | 1.022E−04 | −8.025E−06 | −6.232E−04 | −7.594E−04 | −2.819E−04 | −3.991E−04 |
| B | 2.742E−06 | 1.045E−06 | 3.244E−05 | 1.710E−05 | −4.010E−05 | −6.096E−05 |
| C | −4.805E−07 | −5.031E−08 | −7.332E−07 | −3.826E−08 | −3.684E−06 | 7.574E−08 |
| D | 4.996E−08 | −1.163E−08 | 3.146E−08 | −1.030E−07 | 1.048E−07 | −2.045E−07 |
| E | −2.633E−09 | −1.719E−09 | −3.310E−09 | 8.422E−09 | 8.720E−09 | 8.264E−09 |
| F | −9.181E−11 | 0.000E+00 | 2.049E−12 | 1.386E−09 | 6.421E−10 | 4.510E−09 |
| G | 1.513E−12 | 0.000E+00 | −2.650E−13 | −6.856E−11 | 2.722E−10 | 9.826E−10 |
| H | 3.756E−13 | 0.000E+00 | 1.173E−13 | −1.663E−11 | 2.160E−11 | −1.277E−10 |
| J | −1.740E−14 | 0.000E+00 | 0.000E+00 | 0.000E+00 | −3.100E−12 | 3.404E−12 |
| L | 0 | 0 | 0 | 0 | 0 | 0 |
| M | 0 | 0 | 0 | 0 | 0 | 0 |
| N | 0 | 0 | 0 | 0 | 0 | 0 |
| O | 0 | 0 | 0 | 0 | 0 | 0 |
| P | 0 | 0 | 0 | 0 | 0 | 0 |

| Surface | | | | | | |
|---|---|---|---|---|---|---|
| No. | S7 | S8 | S9 | S10 | S11 | S12 |
| K | 0.000E+00 | 0.000E+00 | −1.262E+00 | 0.000E+00 | 2.280E+01 | 0.000E+00 |
| A | −7.166E−04 | −3.517E−04 | 1.127E−03 | 4.709E−04 | −1.496E−02 | −1.344E−02 |
| B | −1.002E−04 | −9.722E−05 | 1.244E−04 | 4.227E−04 | 3.099E−04 | 5.648E−04 |
| C | −1.199E−05 | −8.623E−06 | 1.803E−06 | −3.505E−05 | −1.569E−04 | −1.125E−04 |
| D | −9.466E−07 | 3.444E−07 | −2.154E−06 | 5.998E−06 | 4.178E−05 | 1.893E−05 |
| E | −2.252E−07 | −7.376E−08 | 8.977E−07 | 0 | −6.590E−06 | −1.634E−06 |
| F | 0 | 0 | −8.143E−09 | 0 | 1.868E−07 | −5.146E−08 |
| G | 0 | 0 | −4.086E−09 | 0 | 2.776E−09 | −6.965E−10 |
| H | 0 | 0 | 0 | 0 | 0 | 1.147E−09 |
| J | 0 | 0 | 0 | 0 | 0 | 0 |
| L | 0 | 0 | 0 | 0 | 0 | 0 |
| M | 0 | 0 | 0 | 0 | 0 | 0 |
| N | 0 | 0 | 0 | 0 | 0 | 0 |
| O | 0 | 0 | 0 | 0 | 0 | 0 |
| P | 0 | 0 | 0 | 0 | 0 | 0 |

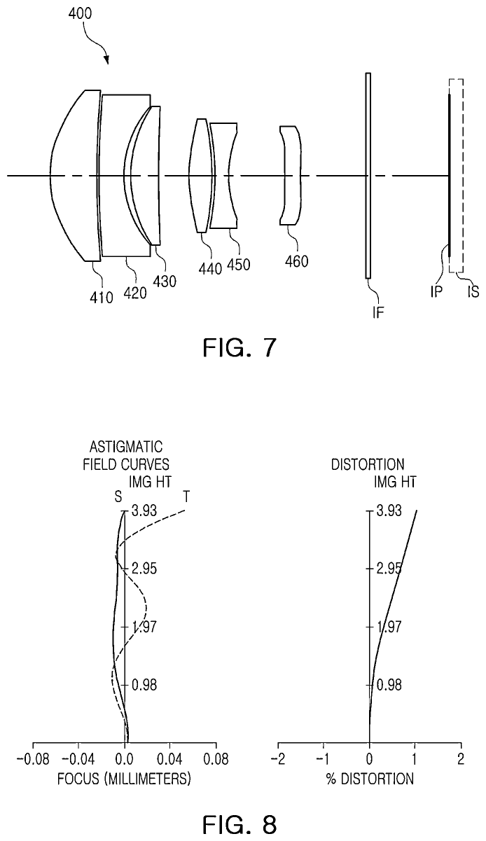

An imaging lens system 400 according to a fourth example of the one or more embodiments will be described with reference to FIG. 7.

The imaging lens system 400 may include a plurality of lens groups. For example, the imaging lens system 400 may include a first lens 410, a second lens 420, a third lens 430, a fourth lens 440, a fifth lens 450, and a sixth lens 460, sequentially arranged from an object side toward an imaging plane.

The first lens 410 may have positive refractive power, and may have a convex object-side surface and a concave image-side surface. The second lens 420 may have negative refractive power, and may have a convex object-side surface and a concave image-side surface. The third lens 430 may have positive refractive power, and may have a convex object-side surface and a concave image-side surface. The fourth lens 440 may have positive refractive power, and may have a convex object-side surface and a convex image-side surface. The fifth lens 450 may have negative refractive power, and may have a concave object-side surface and a concave image-side surface. The sixth lens 460 may have negative refractive power, and may have a convex object-side surface and a concave image-side surface.

The imaging lens system 400 may further include a filter IF and an imaging plane IP. The imaging plane IP may be formed on an image sensor IS, and the filter IF may be disposed between the sixth lens 460 and the imaging plane IP.

The imaging lens system 400 configured as above exhibits aberration characteristics as illustrated in FIG. 8. Tables 7 and 8 below illustrates the lens characteristics and aspherical values of the imaging lens system according to the present example.

TABLE 7

| Surface | | Curvature | Thickness/ | Refractive | Abbe | Effective | Effective |
|---|---|---|---|---|---|---|---|
| No. | Component | Radius | Distance | Index | No. | Radius (Xc) | Radius (Yc) |
| S1 | 1st Lens | 5.815 | 2.170 | 1.535 | 55.70 | 4.150 | 3.225 |
| S2 | | 50.969 | 0.080 | | | 3.972 | 3.225 |
| S3 | 2nd Lens | 35.159 | 1.166 | 1.614 | 25.90 | 3.932 | 3.225 |
| S4 | | 4.821 | 0.263 | | | 3.374 | 3.225 |
| S5 | 3rd Lens | 5.635 | 1.310 | 1.544 | 56.00 | 3.374 | 3.225 |
| S6 | | 44.552 | 1.399 | | | 3.290 | 3.225 |
| S7 | 4th Lens | 8.440 | 1.053 | 1.671 | 19.20 | 2.756 | 2.756 |
| S8 | | −19.044 | 0.115 | | | 2.648 | 2.648 |
| S9 | 5th Lens | −10.937 | 0.619 | 1.614 | 25.90 | 2.551 | 2.551 |
| S10 | | 6.034 | 2.602 | | | 2.150 | 2.150 |
| S11 | 6th Lens | 20.939 | 0.746 | 1.544 | 56.00 | 2.150 | 2.150 |
| S12 | | 17.851 | 3.000 | | | 2.392 | 2.392 |
| S13 | Filter | Infinity | 0.210 | 1.518 | 64.17 | 5.000 | 5.000 |
| S14 | | Infinity | 3.570 | | | 5.000 | 5.000 |
| S15 | Imaging | Infinity | −0.003 | | | 3.938 | 3.938 |
| | plane | | | | | | |

TABLE 8

| Surface | | | | | | |
|---|---|---|---|---|---|---|
| No. | S1 | S2 | S3 | S4 | S5 | S6 |
| K | −5.021E−01 | 0.000E+00 | 0.000E+00 | −4.080E−01 | −1.152E−01 | 5.132E+01 |
| A | 1.117E−04 | −1.941E−06 | −6.059E−04 | −8.023E−04 | −2.133E−04 | −1.182E−04 |
| B | 1.560E−06 | 1.077E−06 | 3.367E−05 | 1.280E−05 | −3.499E−04 | −7.695E−04 |
| C | −5.732E−07 | −4.244E−08 | −6.607E−07 | −3.486E−07 | 1.523E−04 | 4.173E−04 |
| D | 5.001E−08 | −7.705E−09 | 3.550E−08 | −1.169E−07 | −3.661E−05 | −1.216E−04 |
| E | −2.395E−09 | −1.068E−09 | −3.242E−09 | 8.608E−09 | 5.006E−06 | 2.116E−05 |
| F | −7.696E−11 | 0.000E+00 | −7.152E−12 | 1.613E−09 | −4.135E−07 | −2.306E−06 |
| G | 1.952E−12 | 0.000E+00 | −9.138E−13 | −2.037E−11 | 2.002E−08 | 1.556E−07 |
| H | 3.826E−13 | 0.000E+00 | 2.029E−13 | −1.001E−11 | −4.459E−10 | −5.914E−09 |
| J | −1.663E−14 | 0.000E+00 | 0.000E+00 | 0.000E+00 | 1.132E−12 | 9.652E−11 |
| L | 0 | 0 | 0 | 0 | 0 | 0 |
| M | 0 | 0 | 0 | 0 | 0 | 0 |
| N | 0 | 0 | 0 | 0 | 0 | 0 |
| O | 0 | 0 | 0 | 0 | 0 | 0 |
| P | 0 | 0 | 0 | 0 | 0 | 0 |

| Surface | | | | | | |
|---|---|---|---|---|---|---|
| No. | S7 | S8 | S9 | S10 | S11 | S12 |
| K | 1.582E+00 | 2.831E−01 | −3.724E−01 | 1.420E−01 | 3.520E+01 | 0.000E+00 |
| A | 1.421E−03 | 5.193E−03 | 2.278E−03 | −2.645E−03 | −1.486E−02 | −1.337E−02 |
| B | −2.709E−03 | −1.156E−02 | −6.160E−03 | 5.302E−03 | 2.735E−04 | 5.757E−04 |
| C | 1.538E−03 | 9.537E−03 | 6.912E−03 | −3.641E−03 | −1.425E−04 | −1.216E−04 |
| D | −5.473E−04 | −4.312E−03 | −3.458E−03 | 1.977E−03 | 3.674E−05 | 1.874E−05 |
| E | 1.204E−04 | 1.154E−03 | 9.532E−04 | −7.911E−04 | −6.590E−06 | −1.633E−06 |
| F | −1.743E−05 | −1.882E−04 | −1.521E−04 | 2.145E−04 | 1.870E−07 | −5.136E−08 |
| G | 1.694E−06 | 1.839E−05 | 1.367E−05 | −3.677E−05 | 2.776E−09 | −6.611E−10 |
| H | −1.021E−07 | −9.931E−07 | −6.127E−07 | 3.562E−06 | 0.000E+00 | 1.147E−09 |
| J | 2.855E−09 | 2.284E−08 | 9.440E−09 | −1.479E−07 | 0.000E+00 | 0.000E+00 |
| L | 0 | 0 | 0 | 0 | 0 | 0 |
| M | 0 | 0 | 0 | 0 | 0 | 0 |
| N | 0 | 0 | 0 | 0 | 0 | 0 |
| O | 0 | 0 | 0 | 0 | 0 | 0 |
| P | 0 | 0 | 0 | 0 | 0 | 0 |

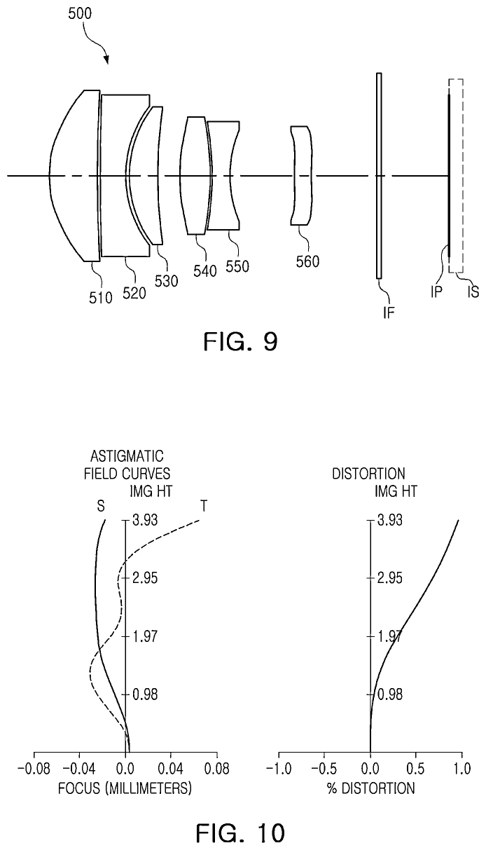

An imaging lens system 500 according to a fifth example of the one or more embodiments will be described with reference to FIG. 9.

The imaging lens system 500 may include a first lens 510, a second lens 520, a third lens 530, a fourth lens 540, a fifth lens 550, and a sixth lens 560, sequentially arranged from an object side toward an imaging plane.

The first lens 510 may have positive refractive power, and may have a convex object-side surface and a concave image-side surface. The second lens 520 may have negative refractive power, and may have a convex object-side surface and a concave image-side surface. The third lens 530 may have positive refractive power, and may have a convex object-side surface and a concave image-side surface. The fourth lens 540 may have positive refractive power, and may have a convex object-side surface and a convex image-side surface. The fifth lens 550 may have negative refractive power, and may have a concave object-side surface and a concave image-side surface. The sixth lens 560 may have negative refractive power, and may have a convex object-side surface and a concave image-side surface.

The imaging lens system 500 may further include a filter IF and an imaging plane IP. The imaging plane IP may be formed on an image sensor IS, and the filter IF may be disposed between the sixth lens 560 and the imaging plane IP.

The imaging lens system 500 configured as above exhibits aberration characteristics as illustrated in FIG. 10. Table 9 and Table 10 below illustrate lens characteristics and aspherical values of the imaging lens system according to the present example.

TABLE 9

| Surface | | Curvature | Thickness/ | Refractive | Abbe | Effective | Effective |
|---|---|---|---|---|---|---|---|
| No. | Component | Radius | Distance | Index | No. | Radius (Xc) | Radius (Yc) |
| S1 | 1st Lens | 5.979 | 2.234 | 1.535 | 55.70 | 4.150 | 3.225 |
| S2 | | 79.624 | 0.108 | | | 3.964 | 3.225 |
| S3 | 2nd Lens | 63.741 | 1.188 | 1.614 | 25.90 | 3.923 | 3.225 |
| S4 | | 5.097 | 0.156 | | | 3.354 | 3.225 |
| S5 | 3rd Lens | 5.433 | 1.332 | 1.544 | 56.00 | 3.351 | 3.225 |
| S6 | | 26.320 | 0.989 | | | 3.237 | 3.225 |
| S7 | 4th Lens | 9.155 | 1.400 | 1.671 | 19.20 | 2.876 | 2.876 |
| S8 | | −19.951 | 0.080 | | | 2.687 | 2.687 |
| S9 | 5th Lens | −11.140 | 0.795 | 1.614 | 25.90 | 2.621 | 2.621 |
| S10 | | 7.275 | 3.000 | | | 2.200 | 2.200 |
| S11 | 6th Lens | 20.038 | 0.755 | 1.544 | 56.00 | 2.200 | 2.200 |
| S12 | | 14.480 | 3.000 | | | 2.438 | 2.438 |
| S13 | Filter | Infinity | 0.210 | 1.518 | 64.17 | 5.000 | 5.000 |
| S14 | | Infinity | 3.155 | | | 5.000 | 5.000 |
| S15 | Imaging | Infinity | −0.003 | | | 3.933 | 3.933 |
| | plane | | | | | | |

TABLE 10

| Surface | | | | | | |
|---|---|---|---|---|---|---|
| No. | S1 | S2 | S3 | S4 | S5 | S6 |
| K | −4.486E−01 | 0.000E+00 | 0.000E+00 | −4.830E−01 | −1.323E−01 | 3.829E+01 |
| A | 1.758E−04 | 1.131E−05 | −5.794E−04 | −9.124E−04 | −9.855E−04 | −1.272E−03 |
| B | −1.104E−06 | −4.087E−07 | 3.399E−05 | 7.290E−06 | −3.809E−04 | −8.540E−04 |
| C | −6.042E−07 | −2.389E−07 | −7.153E−07 | −1.022E−07 | 2.075E−04 | 6.348E−04 |
| D | 5.792E−08 | −6.953E−09 | 3.425E−08 | −6.682E−08 | −4.768E−05 | −1.915E−04 |
| E | −2.070E−09 | 1.302E−10 | −3.175E−09 | 1.274E−08 | 6.099E−06 | 3.380E−05 |
| F | −8.127E−11 | 0 | 2.929E−11 | 1.874E−09 | −4.306E−07 | −3.802E−06 |
| G | 1.894E−12 | 0 | 3.030E−12 | −1.255E−11 | 1.142E−08 | 2.679E−07 |
| H | 3.874E−13 | 0 | 1.329E−13 | −1.080E−11 | 4.480E−10 | −1.062E−08 |
| J | −1.900E−14 | 0 | 0 | 0 | −2.789E−11 | 1.763E−10 |
| L | 0 | 0 | 0 | 0 | 0 | 0 |
| M | 0 | 0 | 0 | 0 | 0 | 0 |
| N | 0 | 0 | 0 | 0 | 0 | 0 |
| O | 0 | 0 | 0 | 0 | 0 | 0 |
| P | 0 | 0 | 0 | 0 | 0 | 0 |

| Surface | | | | | | |
|---|---|---|---|---|---|---|
| No. | S7 | S8 | S9 | S10 | S11 | S12 |
| K | 2.434E+00 | −7.865E−01 | −1.000E+00 | 1.000E+00 | 2.000E+01 | 7.499E+00 |
| A | 9.781E−05 | 2.891E−03 | 2.516E−03 | 5.295E−04 | −1.520E−02 | −1.522E−02 |
| B | −1.851E−03 | −9.508E−03 | −7.097E−03 | 1.314E−03 | 7.196E−03 | 6.325E−03 |
| C | 1.183E−03 | 7.972E−03 | 7.063E−03 | −3.622E−05 | −1.296E−02 | −7.754E−03 |
| D | −4.133E−04 | −3.442E−03 | −3.268E−03 | −3.160E−04 | 1.377E−02 | 6.191E−03 |
| E | 8.692E−05 | 8.768E−04 | 8.780E−04 | 2.058E−04 | −9.216E−03 | −3.225E−03 |
| F | −1.200E−05 | −1.384E−04 | −1.459E−04 | −6.623E−05 | 4.067E−03 | 1.127E−03 |
| G | 1.081E−06 | 1.341E−05 | 1.491E−05 | 1.195E−05 | −1.204E−03 | −2.670E−04 |
| H | −5.727E−08 | −7.362E−07 | −8.678E−07 | −1.169E−06 | 2.369E−04 | 4.234E−05 |
| J | 1.335E−09 | 1.766E−08 | 2.225E−08 | 4.874E−08 | −2.978E−05 | −4.309E−06 |
| L | 0 | 0 | 0 | 0 | 2.167E−06 | 2.547E−07 |
| M | 0 | 0 | 0 | 0 | −6.945E−08 | −6.650E−09 |
| N | 0 | 0 | 0 | 0 | 0 | 0 |
| O | 0 | 0 | 0 | 0 | 0 | 0 |
| P | 0 | 0 | 0 | 0 | 0 | 0 |

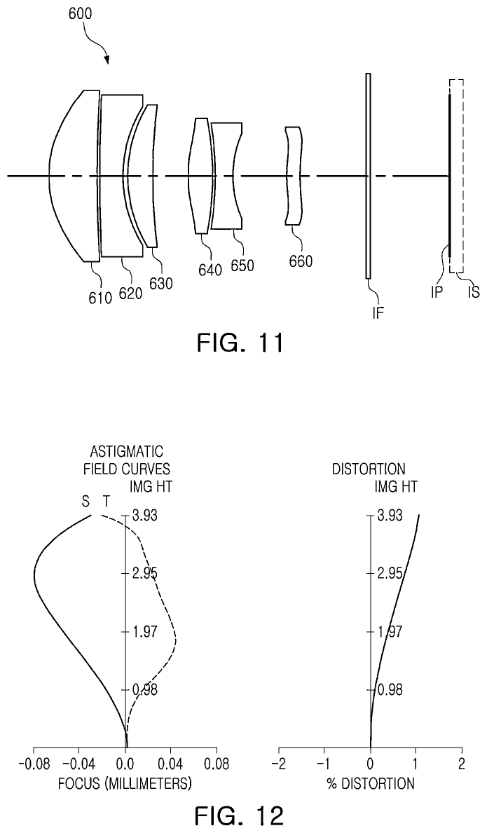

An imaging lens system 600 according to a sixth example of the one or more embodiments will be described with reference to FIG. 11.

The imaging lens system 600 may include a plurality of lens groups. For example, the imaging lens system 600 may include a first lens 610, a second lens 620, a third lens 630, a fourth lens 640, a fifth lens 650, and a sixth lens 660, sequentially arranged from an object side toward an imaging plane.

The first lens 610 may have positive refractive power, and may have a convex object-side surface and a concave image-side surface. The second lens 620 may have negative refractive power, and may have a convex object-side surface and a concave image-side surface. The third lens 630 may have positive refractive power, and may have a convex object-side surface and a concave image-side surface. The fourth lens 640 may have positive refractive power, and may have a convex object-side surface and a convex image-side surface. The fifth lens 650 may have negative refractive power, and may have a concave object-side surface and a concave image-side surface. The sixth lens 660 may have negative refractive power, and may have a convex object-side surface and a concave image-side surface.

The imaging lens system 600 may further include a filter IF and an imaging plane IP. The imaging plane IP may be formed on an image sensor IS, and the filter IF may be disposed between the sixth lens 660 and the imaging plane IP.

The imaging lens system 600 configured as above exhibits aberration characteristics as illustrated in FIG. 12. Tables 11 and 12 below illustrates lens characteristics and aspherical values of the imaging lens system according to the present example.

TABLE 11

| Surface | | Curvature | Thickness/ | Refractive | Abbe | Effective | Effective |
|---|---|---|---|---|---|---|---|
| No | Component | Radius | Distance | Index | No. | Radius (Xc) | Radius (Yc) |
| S1 | 1st Lens | 6.077 | 2.196 | 1.535 | 55.70 | 4.150 | 3.225 |
| S2 | | 104.344 | 0.144 | | | 3.968 | 3.225 |
| S3 | 2nd Lens | 66.596 | 1.102 | 1.639 | 23.50 | 3.917 | 3.225 |
| S4 | | 6.294 | 0.216 | | | 3.457 | 3.225 |
| S5 | 3rd Lens | 6.731 | 1.148 | 1.535 | 55.70 | 3.447 | 3.225 |
| S6 | | 25.479 | 1.627 | | | 3.342 | 3.225 |
| S7 | 4th Lens | 8.454 | 1.136 | 1.671 | 19.20 | 2.800 | 2.800 |
| S8 | | −19.750 | 0.080 | | | 2.684 | 2.684 |
| S9 | 5th Lens | −12.043 | 0.827 | 1.614 | 25.90 | 2.582 | 2.582 |
| S10 | | 6.539 | 2.474 | | | 2.120 | 2.120 |
| S11 | 6th Lens | 6.925 | 0.600 | 1.544 | 56.00 | 2.200 | 2.200 |
| S12 | | 6.154 | 3.000 | | | 2.376 | 2.376 |
| S13 | Filter | Infinity | 0.210 | 1.518 | 64.17 | 5.000 | 5.000 |
| S14 | | Infinity | 3.641 | | | 5.000 | 5.000 |
| S15 | Imaging | Infinity | 0.000 | | | 3.931 | 3.931 |
| | plane | | | | | | |

TABLE 12

| Surface | | | | | | |
|---|---|---|---|---|---|---|
| No. | S1 | S2 | S3 | S4 | S5 | S6 |
| K | −4.789E−01 | 0.000E+00 | 0.000E+00 | −5.186E−01 | 1.254E−02 | 3.552E+01 |
| A | 1.464E−04 | 1.105E−05 | −6.104E−04 | −9.550E−04 | −1.346E−03 | −1.865E−03 |
| B | −2.276E−06 | −3.856E−07 | 3.241E−05 | 4.264E−06 | 1.100E−04 | 2.529E−04 |
| C | −5.626E−07 | −2.434E−07 | −8.105E−07 | −1.761E−07 | −1.238E−06 | 2.014E−05 |
| D | 6.082E−08 | −5.099E−09 | 2.969E−08 | −5.799E−08 | 1.051E−06 | −1.527E−05 |
| E | −2.146E−09 | 3.052E−10 | −3.114E−09 | 1.413E−08 | −1.057E−06 | 2.557E−06 |
| F | −9.189E−11 | 0 | 5.814E−11 | 2.019E−09 | 2.279E−07 | −2.052E−07 |
| G | 1.387E−12 | 0 | 4.806E−12 | −2.478E−13 | −2.179E−08 | 7.646E−09 |
| H | 4.223E−13 | 0 | −1.023E−13 | −1.052E−11 | 1.045E−09 | −3.896E−11 |
| J | −1.521E−14 | 0 | 0 | 0 | −2.116E−11 | −4.028E−12 |
| L | 0 | 0 | 0 | 0 | 0 | 0 |
| M | 0 | 0 | 0 | 0 | 0 | 0 |
| N | 0 | 0 | 0 | 0 | 0 | 0 |
| O | 0 | 0 | 0 | 0 | 0 | 0 |
| P | 0 | 0 | 0 | 0 | 0 | 0 |

| Surface | | | | | | |
|---|---|---|---|---|---|---|
| No. | S7 | S8 | S9 | S10 | S11 | S12 |
| K | 1.154E+00 | −1.000E+00 | −5.373E−01 | 1.892E−01 | −8.684E+00 | −9.245E+00 |
| A | −9.435E−04 | −1.297E−03 | −1.792E−03 | −1.787E−03 | −1.647E−02 | −1.499E−02 |
| B | 3.358E−05 | 2.193E−04 | 1.906E−03 | 2.381E−03 | −1.459E−03 | −8.699E−04 |
| C | −6.408E−05 | −6.457E−05 | −4.315E−04 | −6.057E−04 | 3.669E−03 | 2.379E−03 |
| D | 2.970E−05 | 5.909E−05 | 1.092E−04 | 1.364E−04 | −4.014E−03 | −2.198E−03 |
| E | −1.471E−05 | −2.549E−05 | −2.250E−05 | −2.129E−05 | 2.860E−03 | 1.321E−03 |
| F | 3.842E−06 | 4.746E−06 | 1.235E−06 | −5.634E−07 | −1.361E−03 | −5.341E−04 |
| G | −5.281E−07 | −4.307E−07 | 3.034E−07 | 8.207E−07 | 4.338E−04 | 1.456E−04 |
| H | 3.680E−08 | 1.804E−08 | −4.901E−08 | −1.158E−07 | −9.153E−05 | −2.636E−05 |
| J | −1.023E−09 | −2.372E−10 | 2.096E−09 | 5.114E−09 | 1.225E−05 | 3.038E−06 |
| L | 0 | 0 | 0 | 0 | −9.425E−07 | −2.017E−07 |
| M | 0 | 0 | 0 | 0 | 3.171E−08 | 5.873E−09 |
| N | 0 | 0 | 0 | 0 | 0 | 0 |
| O | 0 | 0 | 0 | 0 | 0 | 0 |
| P | 0 | 0 | 0 | 0 | 0 | 0 |

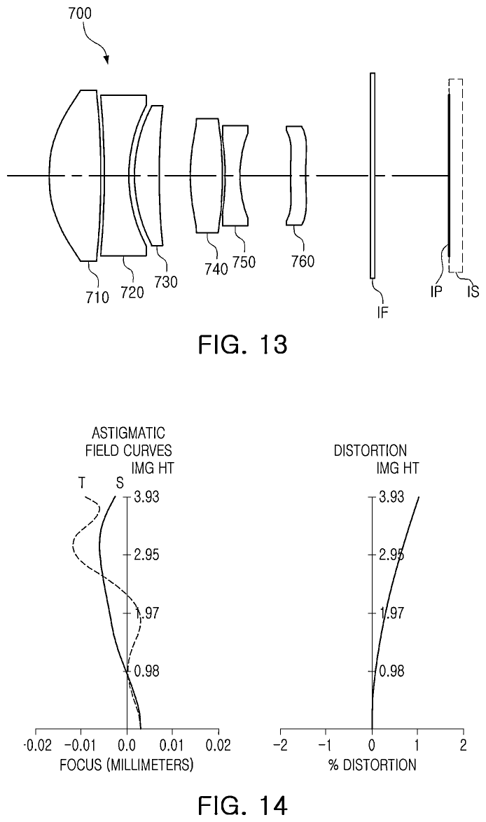

An imaging lens system 700 according to a seventh example of the one or more embodiments will be described with reference to FIG. 13.

The imaging lens system 700 may include a plurality of lens groups. For example, the imaging lens system 700 may include a first lens 710, a second lens 720, a third lens 730, a fourth lens 740, a fifth lens 750, and a sixth lens 760, sequentially arranged from an object side toward an imaging plane.

The first lens 710 may have positive refractive power, and may have a convex object-side surface and a convex image-side surface. The second lens 720 may have negative refractive power, and may have a concave object-side surface and a concave image-side surface. The third lens 730 may have positive refractive power, and may have a convex object-side surface and a concave image-side surface. The fourth lens 740 may have positive refractive power, and may have a convex object-side surface and a convex image-side surface. The fifth lens 750 may have negative refractive power, and may have a concave object-side surface and a concave image-side surface. The sixth lens 760 may have negative refractive power, and may have a convex object-side surface and a concave image-side surface.

The imaging lens system 700 may further include a filter IF and an imaging plane IP. The imaging plane IP may be formed on an image sensor IS, and the filter IF may be disposed between the sixth lens 760 and the imaging plane IP.

The imaging lens system 700 configured as above exhibits aberration characteristics as illustrated in FIG. 14. Tables 13 and 14 below illustrate lens characteristics and aspherical values of the imaging lens system according to the present example.

TABLE 13

| Surface | | Curvature | Thickness/ | Refractive | Abbe | Effective | Effective |
|---|---|---|---|---|---|---|---|
| No. | Component | Radius | Distance | Index | No. | Radius (Xc) | Radius (Yc) |
| S1 | 1st Lens | 6.213 | 2.400 | 1.535 | 55.70 | 4.150 | 3.225 |
| S2 | | −52.685 | 0.104 | | | 3.968 | 3.225 |
| S3 | 2nd Lens | −164.644 | 1.176 | 1.614 | 25.90 | 3.905 | 3.225 |
| S4 | | 6.114 | 0.217 | | | 3.420 | 3.225 |
| S5 | 3rd Lens | 6.512 | 1.157 | 1.535 | 55.70 | 3.393 | 3.225 |
| S6 | | 22.486 | 1.450 | | | 3.284 | 3.225 |
| S7 | 4th Lens | 9.192 | 1.500 | 1.671 | 19.20 | 2.774 | 2.774 |
| S8 | | −23.222 | 0.092 | | | 2.543 | 2.543 |
| S9 | 5th Lens | −13.162 | 0.661 | 1.614 | 25.90 | 2.454 | 2.454 |
| S10 | | 6.916 | 2.363 | | | 2.080 | 2.080 |
| S11 | 6th Lens | 10.263 | 0.679 | 1.544 | 56.00 | 2.200 | 2.200 |
| S12 | | 8.592 | 3.000 | | | 2.415 | 2.415 |
| S13 | Filter | Infinity | 0.210 | 1.518 | 64.17 | 5.000 | 5.000 |
| S14 | | Infinity | 3.393 | | | 5.000 | 5.000 |
| S15 | Imaging | Infinity | −0.003 | | | 3.931 | 3.931 |
| | plane | | | | | | |

TABLE 14

| Surface | | | | | | |
|---|---|---|---|---|---|---|
| No. | S1 | S2 | S3 | S4 | S5 | S6 |
| K | −5.411E−01 | 0.000E+00 | 0.000E+00 | −1.068E+00 | −2.897E−01 | 2.594E+01 |
| A | 5.690E−05 | 1.475E−04 | −5.803E−04 | −1.307E−03 | −1.068E−03 | −1.138E−03 |
| B | 1.215E−06 | 2.764E−06 | 3.015E−05 | −1.478E−07 | 7.167E−05 | 6.900E−05 |
| C | −5.773E−07 | −2.564E−07 | −8.956E−07 | −7.952E−08 | −1.949E−05 | −5.355E−05 |
| D | 5.986E−08 | −1.629E−08 | 3.136E−08 | −6.664E−08 | 5.741E−06 | 2.332E−05 |
| E | −2.037E−09 | −8.802E−10 | −2.919E−09 | 1.180E−08 | −1.154E−06 | −5.500E−06 |
| F | −8.539E−11 | 0 | 6.715E−11 | 1.834E−09 | 1.355E−07 | 7.841E−07 |
| G | 1.268E−12 | 0 | 4.524E−12 | −1.496E−12 | −7.674E−09 | −6.557E−08 |
| H | 3.958E−13 | 0 | −2.233E−13 | −8.396E−12 | 1.467E−10 | 2.898E−09 |
| J | −1.676E−14 | 0 | 0 | 0 | 6.197E−13 | −5.213E−11 |
| L | 0.000E+00 | 0 | 0 | 0 | 0 | 0 |
| M | 0 | 0 | 0 | 0 | 0 | 0 |
| N | 0 | 0 | 0 | 0 | 0 | 0 |
| O | 0 | 0 | 0 | 0 | 0 | 0 |
| P | 0 | 0 | 0 | 0 | 0 | 0 |

| Surface | | | | | | |
|---|---|---|---|---|---|---|
| No. | S7 | S8 | S9 | S10 | S11 | S12 |
| K | −3.415E−01 | 1.095E+00 | −1.951E+00 | −9.027E−02 | −8.384E+00 | −7.950E+00 |
| A | 7.335E−04 | 5.358E−03 | −1.605E−03 | −8.717E−03 | −2.136E−02 | −1.963E−02 |
| B | −6.676E−04 | −3.866E−03 | 1.490E−03 | 6.651E−03 | −5.163E−04 | 6.752E−04 |
| C | −7.911E−05 | 8.069E−04 | −3.426E−04 | −2.252E−03 | 3.092E−03 | 1.458E−03 |
| D | 7.646E−05 | 3.652E−06 | 2.243E−04 | 9.070E−04 | −3.116E−03 | −1.450E−03 |
| E | −2.738E−05 | −2.608E−05 | −8.724E−05 | −3.394E−04 | 1.983E−03 | 8.428E−04 |
| F | 5.951E−06 | 4.157E−06 | 1.975E−05 | 8.689E−05 | −8.363E−04 | −3.207E−04 |
| G | −7.475E−07 | −3.304E−07 | −2.871E−06 | −1.356E−05 | 2.356E−04 | 8.100E−05 |
| H | 4.952E−08 | 1.962E−08 | 2.453E−07 | 1.155E−06 | −4.384E−05 | −1.345E−05 |
| J | −1.342E−09 | −7.626E−10 | −9.052E−09 | −4.061E−08 | 5.170E−06 | 1.413E−06 |
| L | 0 | 0 | 0 | 0 | −3.497E−07 | −8.506E−08 |
| M | 0 | 0 | 0 | 0 | 1.032E−08 | 2.237E−09 |
| N | 0 | 0 | 0 | 0 | 0.000E+00 | 0.000E+00 |
| O | 0 | 0 | 0 | 0 | 0 | 0 |
| P | 0 | 0 | 0 | 0 | 0 | 0 |

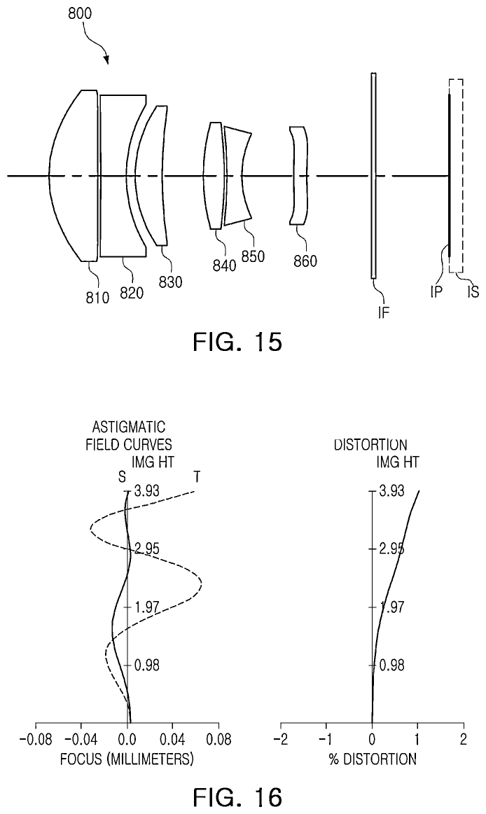

An imaging lens system 800 according to an eighth example of the one or more embodiments will be described with reference to FIG. 15.

The imaging lens system 800 may include a plurality of lens groups. For example, the imaging lens system 800 may include a first lens 810, a second lens 820, a third lens 830, a fourth lens 840, a fifth lens 850, and a sixth lens 860, sequentially arranged from an object side toward an imaging plane.

The first lens 810 may have positive refractive power, and may have a convex object-side surface and a convex image-side surface. The second lens 820 may have negative refractive power, and may have a concave object-side surface and a concave image-side surface. The third lens 830 may have positive refractive power, and may have a convex object-side surface and a concave image-side surface. The fourth lens 840 may have positive refractive power, and may have a convex object-side surface and a convex image-side surface. The fifth lens 850 may have negative refractive power, and may have a concave object-side surface and a concave image-side surface. The sixth lens 860 may have negative refractive power, and may have a convex object-side surface and a concave image-side surface.

The imaging lens system 800 may further include a filter IF and an imaging plane IP. The imaging plane IP may be formed on an image sensor IS, and the filter IF may be disposed between the sixth lens 860 and the imaging plane IP.

The imaging lens system 800 configured as above exhibits aberration characteristics as illustrated in FIG. 16. Table 15 and Table 16 below illustrate lens characteristics and aspherical values of the imaging lens system according to the present example.

TABLE 15

| Surface | | Curvature | Thickness/ | Refractive | Abbe | Effective | Effective |
|---|---|---|---|---|---|---|---|
| No. | Component | Radius | Distance | Index | No. | Radius (Xc) | Radius (Yc) |
| S1 | 1st Lens | 6.112 | 2.250 | 1.535 | 55.70 | 4.150 | 3.225 |
| S2 | | −286.053 | 0.141 | | | 3.987 | 3.225 |
| S3 | 2nd Lens | −269.169 | 1.176 | 1.614 | 25.90 | 3.933 | 3.225 |
| S4 | | 6.070 | 0.379 | | | 3.443 | 3.225 |
| S5 | 3rd Lens | 5.794 | 1.261 | 1.535 | 55.70 | 3.397 | 3.225 |
| S6 | | 20.544 | 1.886 | | | 3.266 | 3.225 |
| S7 | 4th Lens | 8.269 | 0.973 | 1.671 | 19.20 | 2.606 | 2.606 |
| S8 | | −28.894 | 0.084 | | | 2.488 | 2.488 |
| S9 | 5th Lens | −24.209 | 0.729 | 1.614 | 25.90 | 2.424 | 2.424 |
| S10 | | 5.349 | 2.374 | | | 2.080 | 2.080 |
| S11 | 6th Lens | 12.183 | 0.600 | 1.544 | 56.00 | 2.200 | 2.200 |
| S12 | | 9.999 | 3.000 | | | 2.389 | 2.389 |
| S13 | Filter | Infinity | 0.210 | 1.518 | 64.17 | 5.000 | 5.000 |
| S14 | | Infinity | 3.340 | | | 5.000 | 5.000 |
| S15 | Imaging | Infinity | −0.003 | | | 3.931 | 3.931 |
| | plane | | | | | | |

TABLE 16

| Surface | | | | | | |
|---|---|---|---|---|---|---|
| No. | S1 | S2 | S3 | S4 | S5 | S6 |
| K | −5.400E−01 | 0.000E+00 | 0.000E+00 | −6.425E−01 | −1.138E−01 | 0.000E+00 |
| A | 6.825E−06 | 1.432E−04 | −5.145E−05 | −1.033E−03 | −6.667E−04 | −5.857E−05 |
| B | −1.340E−05 | 3.650E−06 | −6.304E−07 | 6.048E−06 | 4.392E−05 | −8.348E−06 |
| C | 7.719E−06 | −2.288E−07 | 2.395E−09 | −2.362E−07 | −2.258E−05 | −3.962E−07 |
| D | −1.700E−06 | −1.823E−08 | 9.130E−10 | −1.033E−07 | 6.511E−06 | −3.979E−09 |
| E | 2.175E−07 | −1.285E−09 | 6.488E−11 | 9.642E−09 | −1.181E−06 | 2.545E−09 |
| F | −1.704E−08 | 0 | 3.245E−12 | 1.690E−09 | 1.296E−07 | 0 |
| G | 7.985E−10 | 0 | 0 | −7.128E−12 | −8.139E−09 | 0 |
| H | −2.060E−11 | 0 | 0 | −8.413E−12 | 2.785E−10 | 0 |
| J | 2.171E−13 | 0 | 0 | 0 | −4.456E−12 | 0 |
| L | 0 | 0 | 0 | 0 | 0 | 0 |
| M | 0 | 0 | 0 | 0 | 0 | 0 |
| N | 0 | 0 | 0 | 0 | 0 | 0 |
| O | 0 | 0 | 0 | 0 | 0 | 0 |
| P | 0 | 0 | 0 | 0 | 0 | 0 |

| Surface | | | | | | |
|---|---|---|---|---|---|---|
| No. | S7 | S8 | S9 | S10 | S11 | S12 |
| K | 0.000E+00 | 0.000E+00 | 0.000E+00 | 0.000E+00 | 1.000E+01 | −4.004E−02 |
| A | −1.495E−03 | 1.631E−04 | 8.313E−04 | −1.233E−03 | −1.676E−02 | −1.681E−02 |
| B | −2.000E−06 | −3.521E−05 | 1.692E−05 | 3.014E−04 | −1.994E−03 | −1.251E−03 |
| C | −3.569E−07 | −5.334E−06 | −4.736E−06 | 1.917E−05 | 2.539E−03 | 5.401E−03 |
| D | −4.022E−07 | −7.046E−07 | −6.457E−07 | −4.234E−06 | −7.874E−04 | −6.490E−03 |
| E | −5.552E−08 | −2.694E−08 | 5.632E−09 | 3.878E−07 | −7.773E−04 | 4.426E−03 |
| F | 0 | 0 | 0 | 0 | 9.246E−04 | −1.896E−03 |
| G | 0 | 0 | 0 | 0 | −4.445E−04 | 5.293E−04 |
| H | 0 | 0 | 0 | 0 | 1.202E−04 | −9.649E−05 |
| J | 0 | 0 | 0 | 0 | −1.906E−05 | 1.109E−05 |
| L | 0 | 0 | 0 | 0 | 1.656E−06 | −7.304E−07 |
| M | 0 | 0 | 0 | 0 | −6.111E−08 | 2.104E−08 |
| N | 0 | 0 | 0 | 0 | 0 | 0 |
| O | 0 | 0 | 0 | 0 | 0 | 0 |
| P | 0 | 0 | 0 | 0 | 0 | 0 |

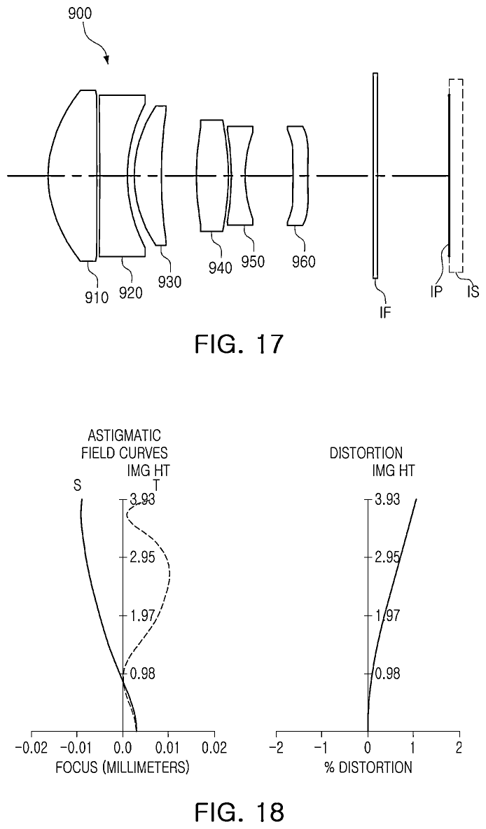

An imaging lens system 900 according to a ninth example of the one or more embodiments will be described with reference to FIG. 17.

The imaging lens system 900 may include a plurality of lens groups. For example, the imaging lens system 900 may include a first lens 910, a second lens 920, a third lens 930, a fourth lens 940, a fifth lens 950, and a sixth lens 960, sequentially arranged from an object side toward an imaging plane.

The first lens 910 may have positive refractive power, and may have a convex object-side surface and a convex image-side surface. The second lens 920 may have negative refractive power, and may have a concave object-side surface and a concave image-side surface. The third lens 930 may have positive refractive power, and may have a convex object-side surface and a concave image-side surface. The fourth lens 940 may have positive refractive power, and may have a convex object-side surface and a convex image-side surface. The fifth lens 950 may have negative refractive power, and may have a concave object-side surface and a concave image-side surface. The sixth lens 960 may have negative refractive power, and may have a convex object-side surface and a concave image-side surface.

The imaging lens system 900 may further include a filter IF and an imaging plane IP. The imaging plane IP may be formed on an image sensor IS, and the filter IF may be disposed between the sixth lens 960 and the imaging plane IP.

The imaging lens system 900 configured as above exhibits aberration characteristics as illustrated in FIG. 18. Tables 17 and 18 below illustrate lens characteristics and aspherical values of the imaging lens system according to the present example.

TABLE 17

| Surface | | Curvature | Thickness/ | Refractive | Abbe | Effective | Effective |
|---|---|---|---|---|---|---|---|
| No. | Component | Radius | Distance | Index | No. | Radius (Xc) | Radius (Yc) |
| S1 | 1st Lens | 6.227 | 2.250 | 1.535 | 55.70 | 4.150 | 3.225 |
| S2 | | −105.059 | 0.142 | | | 4.005 | 3.225 |
| S3 | 2nd Lens | −94.985 | 1.197 | 1.614 | 25.90 | 3.948 | 3.225 |
| S4 | | 6.919 | 0.312 | | | 3.484 | 3.225 |
| S5 | 3rd Lens | 6.130 | 1.292 | 1.535 | 55.70 | 3.435 | 3.225 |
| S6 | | 19.455 | 1.574 | | | 3.308 | 3.225 |
| S7 | 4th Lens | 12.193 | 1.500 | 1.671 | 19.20 | 2.711 | 2.711 |
| S8 | | −16.492 | 0.080 | | | 2.504 | 2.504 |
| S9 | 5th Lens | −16.588 | 0.678 | 1.614 | 25.90 | 2.419 | 2.419 |
| S10 | | 6.982 | 2.202 | | | 2.090 | 2.090 |
| S11 | 6th Lens | 28.645 | 0.672 | 1.544 | 56.00 | 2.200 | 2.200 |
| S12 | | 14.474 | 3.000 | | | 2.423 | 2.423 |
| S13 | Filter | Infinity | 0.210 | 1.518 | 64.17 | 5.000 | 5.000 |
| S14 | | Infinity | 3.295 | | | 5.000 | 5.000 |
| S15 | Imaging | Infinity | −0.003 | | | 3.931 | 3.931 |
| | plane | | | | | | |

TABLE 18

| Surface | | | | | | |
|---|---|---|---|---|---|---|
| No. | S1 | S2 | S3 | S4 | S5 | S6 |
| K | −5.704E−01 | 0.000E+00 | 0.000E+00 | −2.253E−01 | 0.000E+00 | 0.000E+00 |
| A | 5.283E−05 | 1.972E−04 | −2.142E−06 | −7.760E−04 | −1.879E−04 | −5.171E−05 |
| B | −1.011E−05 | 1.626E−06 | 2.028E−07 | 4.421E−06 | 1.645E−05 | −2.644E−05 |
| C | 4.164E−06 | −2.232E−07 | −3.905E−09 | 6.281E−07 | −1.252E−06 | −6.932E−07 |
| D | −8.802E−07 | −1.924E−08 | −4.990E−10 | −9.841E−08 | −9.468E−08 | −1.214E−07 |
| E | 1.150E−07 | −1.658E−09 | −1.039E−11 | 2.231E−09 | −1.841E−10 | −9.655E−09 |
| F | −9.520E−09 | 0 | 8.516E−13 | 8.656E−10 | 4.109E−11 | 1.080E−09 |
| G | 4.708E−10 | 0 | 0 | −3.201E−11 | 0 | 0 |
| H | −1.288E−11 | 0 | 0 | −1.978E−12 | 0 | 0 |
| J | 1.410E−13 | 0 | 0 | 0 | 0 | 0 |
| L | 0.000E+00 | 0 | 0 | 0 | 0 | 0 |
| M | 0 | 0 | 0 | 0 | 0 | 0 |
| N | 0 | 0 | 0 | 0 | 0 | 0 |
| O | 0 | 0 | 0 | 0 | 0 | 0 |
| P | 0 | 0 | 0 | 0 | 0 | 0 |

| Surface | | | | | | |
|---|---|---|---|---|---|---|
| No. | S7 | S8 | S9 | S10 | S11 | S12 |
| K | 0.000E+00 | 0.000E+00 | 0.000E+00 | −3.426E−01 | −1.000E+01 | 5.535E+00 |
| A | −8.284E−04 | 1.665E−04 | 4.295E−04 | 5.052E−06 | −1.613E−02 | −1.584E−02 |
| B | −2.508E−05 | −5.500E−05 | 6.997E−05 | 2.209E−04 | 8.237E−05 | 1.138E−03 |
| C | −5.537E−06 | −6.235E−06 | 4.122E−06 | 2.535E−04 | 3.095E−04 | −8.994E−04 |
| D | −5.562E−07 | −6.465E−07 | 3.560E−07 | −2.366E−04 | −2.688E−04 | 9.291E−04 |
| E | −4.473E−08 | 6.454E−08 | 1.381E−07 | 1.398E−04 | 1.821E−04 | −6.150E−04 |
| F | 0 | −1.606E−09 | 0 | −4.933E−05 | −9.083E−05 | 2.634E−04 |
| G | 0 | 0 | 0 | 1.037E−05 | 3.143E−05 | −7.430E−05 |
| H | 0 | 0 | 0 | −1.192E−06 | −7.281E−06 | 1.371E−05 |
| J | 0 | 0 | 0 | 5.806E−08 | 1.073E−06 | −1.592E−06 |
| L | 0 | 0 | 0 | 0 | −9.080E−08 | 1.056E−07 |
| M | 0 | 0 | 0 | 0 | 3.352E−09 | −3.054E−09 |
| N | 0 | 0 | 0 | 0 | 0 | 0 |
| O | 0 | 0 | 0 | 0 | 0 | 0 |
| P | 0 | 0 | 0 | 0 | 0 | 0 |

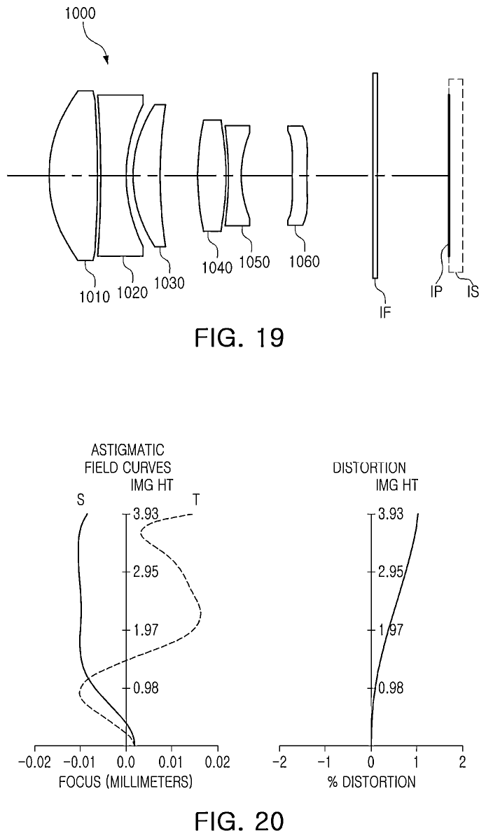

An imaging lens system 1000 according to a tenth example of the one or more embodiments will be described with reference to FIG. 19.

The imaging lens system 1000 may include a plurality of lens groups. For example, the imaging lens system 1000 may include a first lens 1010, a second lens 1020, a third lens 1030, a fourth lens 1040, a fifth lens 1050, and a sixth lens 1060, sequentially arranged from an object side toward an imaging plane.

The first lens 1010 may have positive refractive power, and may have a convex object-side surface and a convex image-side surface. The second lens 1020 may have negative refractive power, and may have a concave object-side surface and a concave image-side surface. The third lens 1030 may have positive refractive power, and may have a convex object-side surface and a concave image-side surface. The fourth lens 1040 may have positive refractive power, and may have a convex object-side surface and a convex image-side surface. The fifth lens 1050 may have negative refractive power, and may have a concave object-side surface and a concave image-side surface. The sixth lens 1060 may have negative refractive power, and may have a convex object-side surface and a concave image-side surface.

The imaging lens system 1000 may further include a filter IF and an imaging plane IP. The imaging plane IP may be formed on an image sensor IS, and the filter IF may be disposed between the sixth lens 1060 and the imaging plane IP.

The imaging lens system 1000 configured as above exhibits aberration characteristics as illustrated in FIG. 20. Tables 19 and 20 below illustrate lens characteristics and aspherical values of the imaging lens system according to the present example.

TABLE 19

| Surface | | Curvature | Thickness/ | Refractive | Abbe | Effective | Effective |
|---|---|---|---|---|---|---|---|
| No. | Component | Radius | Distance | Index | No. | Radius (Xc) | Radius (Yc) |
| S1 | 1st Lens | 6.728 | 2.250 | 1.535 | 55.70 | 4.150 | 3.225 |
| S2 | | −55.085 | 0.130 | | | 4.020 | 3.225 |
| S3 | 2nd Lens | −647.201 | 1.187 | 1.614 | 25.90 | 3.942 | 3.225 |
| S4 | | 6.812 | 0.274 | | | 3.502 | 3.225 |
| S5 | 3rd Lens | 6.140 | 1.274 | 1.535 | 55.70 | 3.453 | 3.225 |
| S6 | | 19.674 | 1.716 | | | 3.327 | 3.225 |
| S7 | 4th Lens | 12.500 | 1.312 | 1.671 | 19.20 | 2.729 | 2.729 |
| S8 | | −18.506 | 0.080 | | | 2.522 | 2.522 |
| S9 | 5th Lens | −22.223 | 0.638 | 1.614 | 25.90 | 2.432 | 2.432 |
| S10 | | 6.636 | 2.318 | | | 2.090 | 2.090 |
| S11 | 6th Lens | 15.761 | 0.672 | 1.544 | 56.00 | 2.200 | 2.200 |
| S12 | | 10.130 | 3.000 | | | 2.430 | 2.430 |
| S13 | Filter | Infinity | 0.210 | 1.518 | 64.17 | 5.000 | 5.000 |
| S14 | | Infinity | 3.342 | | | 5.000 | 5.000 |
| S15 | Imaging | Infinity | −0.002 | | | 3.934 | 3.934 |
| | plane | | | | | | |

TABLE 20

| Surface | | | | | | |
|---|---|---|---|---|---|---|
| No. | S1 | S2 | S3 | S4 | S5 | S6 |
| K | −5.274E−01 | 0.000E+00 | 0.000E+00 | −5.949E−01 | 0.000E+00 | 0.000E+00 |
| A | 3.806E−05 | 1.414E−04 | −7.231E−04 | −1.020E−03 | 1.314E−05 | −1.088E−04 |
| B | −4.969E−06 | 1.949E−06 | 2.622E−05 | 9.080E−06 | −8.825E−07 | −8.848E−06 |
| C | 4.236E−06 | −2.879E−07 | −1.033E−06 | 3.809E−07 | −1.335E−06 | −9.846E−08 |
| D | −1.135E−06 | −2.353E−08 | 3.390E−08 | −1.232E−07 | −7.445E−08 | −7.664E−08 |
| E | 1.761E−07 | −1.669E−09 | −2.374E−09 | 2.621E−09 | −3.349E−10 | −7.743E−09 |
| F | −1.650E−08 | 0 | 1.012E−10 | 1.034E−09 | −5.014E−11 | 5.696E−10 |
| G | 9.078E−10 | 0 | 5.495E−12 | −2.141E−11 | 0 | 0 |
| H | −2.722E−11 | 0 | −2.580E−13 | −2.405E−12 | 0 | 0 |
| J | 3.304E−13 | 0 | 0 | 0 | 0 | 0 |
| L | 0 | 0 | 0 | 0 | 0 | 0 |
| M | 0 | 0 | 0 | 0 | 0 | 0 |
| N | 0 | 0 | 0 | 0 | 0 | 0 |
| O | 0 | 0 | 0 | 0 | 0 | 0 |
| P | 0 | 0 | 0 | 0 | 0 | 0 |

| Surface | | | | | | |
|---|---|---|---|---|---|---|
| No. | S7 | S8 | S9 | S10 | S11 | S12 |
| K | 0.000E+00 | 0.000E+00 | 0.000E+00 | −1.563E−01 | −3.223E−01 | −1.245E+00 |
| A | −2.283E−04 | 1.378E−04 | 2.128E−04 | 6.680E−04 | −1.497E−02 | −1.583E−02 |
| B | −1.247E−05 | −2.776E−05 | 3.267E−05 | 8.087E−05 | −3.770E−03 | 3.938E−04 |
| C | −2.249E−06 | −3.770E−06 | 1.544E−06 | 2.724E−04 | 7.048E−03 | 2.202E−04 |
| D | −2.463E−07 | −4.341E−07 | 2.088E−07 | −2.433E−04 | −7.377E−03 | 3.612E−05 |
| E | −2.913E−08 | 6.696E−08 | 1.220E−07 | 1.367E−04 | 4.977E−03 | −2.043E−04 |
| F | 0 | 1.271E−10 | 0 | −4.644E−05 | −2.259E−03 | 1.473E−04 |
| G | 0 | 0 | 0 | 9.378E−06 | 6.987E−04 | −5.400E−05 |
| H | 0 | 0 | 0 | −1.032E−06 | −1.455E−04 | 1.161E−05 |
| J | 0 | 0 | 0 | 4.760E−08 | 1.952E−05 | −1.484E−06 |
| L | 0 | 0 | 0 | 0 | −1.525E−06 | 1.047E−07 |
| M | 0 | 0 | 0 | 0 | 5.260E−08 | −3.149E−09 |
| N | 0 | 0 | 0 | 0 | 0 | 0 |
| O | 0 | 0 | 0 | 0 | 0 | 0 |
| P | 0 | 0 | 0 | 0 | 0 | 0 |

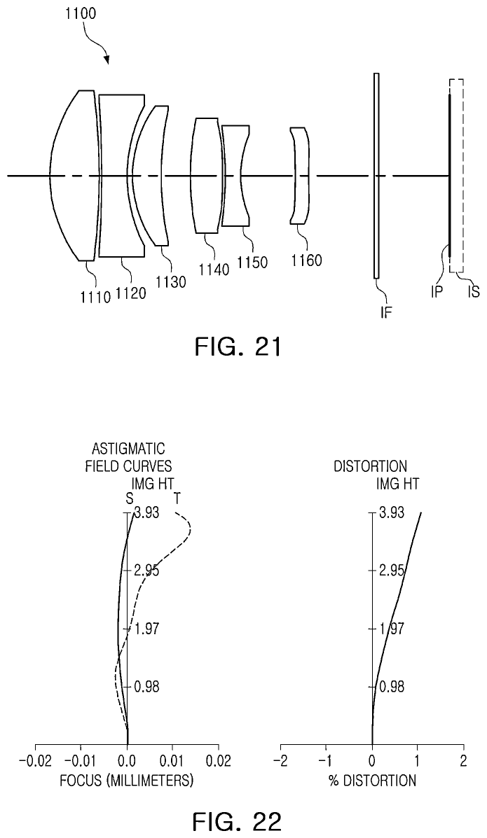

An imaging lens system 1100 according to an eleventh example of the one or more embodiments will be described with reference to FIG. 21.

The imaging lens system 1100 may include a plurality of lens groups. For example, the imaging lens system 1100 may include a first lens 1110, a second lens 1120, a third lens 1130, a fourth lens 1140, a fifth lens 1150, and a sixth lens 1160, sequentially arranged from an object side toward an imaging plane.

The first lens 1110 may have positive refractive power, and may have a convex object-side surface and a convex image-side surface. The second lens 1120 may have negative refractive power, and may have a concave object-side surface and a concave image-side surface. The third lens 1130 may have positive refractive power, and may have a convex object-side surface and a concave image-side surface. The fourth lens 1140 may have positive refractive power, and may have a convex object-side surface and a convex image-side surface. The fifth lens 1150 may have negative refractive power, and may have a concave object-side surface and a concave image-side surface. The sixth lens 1160 may have negative refractive power, and may have a convex object-side surface and a concave image-side surface.

The imaging lens system 1100 may further include a filter IF and an imaging plane IP. The imaging plane IP may be formed on an image sensor IS, and the filter IF may be disposed between the sixth lens 1160 and the imaging plane IP.

The imaging lens system 1100 configured as above exhibits aberration characteristics as illustrated in FIG. 22. Tables 21 and 22 below illustrate lens characteristics and aspherical values of the imaging lens system according to the present example.

TABLE 21

| Surface | | Curvature | Thickness/ | Refractive | Abbe | Effective | Effective |
|---|---|---|---|---|---|---|---|
| No. | Component | Radius | Distance | Index | No. | Radius (Xc) | Radius (Yc) |
| S1 | 1st Lens | 6.724 | 2.300 | 1.535 | 55.7 | 4.150 | 3.225 |
| S2 | | −40.819 | 0.085 | | | 4.014 | 3.225 |
| S3 | 2nd Lens | −612.337 | 1.186 | 1.614 | 25.9 | 3.934 | 3.225 |
| S4 | | 6.666 | 0.232 | | | 3.460 | 3.225 |
| S5 | 3rd Lens | 5.762 | 1.305 | 1.535 | 55.7 | 3.408 | 3.225 |
| S6 | | 14.500 | 1.365 | | | 3.255 | 3.225 |
| S7 | 4th Lens | 11.991 | 1.500 | 1.671 | 19.2 | 2.800 | 2.800 |
| S8 | | −15.830 | 0.080 | | | 2.550 | 2.550 |
| S9 | 5th Lens | −17.295 | 0.748 | 1.614 | 25.9 | 2.453 | 2.453 |
| S10 | | 6.125 | 2.500 | | | 2.050 | 2.050 |
| S11 | 6th Lens | 15.997 | 0.619 | 1.544 | 56 | 2.150 | 2.150 |
| S12 | | 12.231 | 3.000 | | | 2.350 | 2.350 |
| S13 | Filter | Infinity | 0.210 | 1.518 | 64.16641 | 5.000 | 5.000 |
| S14 | | Infinity | 3.272 | | | 5.000 | 5.000 |
| S15 | Imaging | Infinity | −0.002 | | | 3.935 | 3.935 |
| | plane | | | | | | |

TABLE 22

| Surface | | | | | | |
|---|---|---|---|---|---|---|
| No. | S1 | S2 | S3 | S4 | S5 | S6 |
| K | −5.202E−01 | 1.766E+00 | −1.765E+01 | −5.771E−01 | 9.621E−03 | −7.065E−02 |
| A | −1.938E−05 | −2.638E−04 | −6.504E−04 | −2.199E−03 | −2.607E−03 | −1.758E−04 |
| B | 2.032E−05 | 4.711E−04 | −3.327E−05 | 3.368E−03 | 6.385E−03 | 1.081E−03 |
| C | 4.410E−06 | −2.070E−04 | 1.460E−05 | −3.876E−03 | −6.689E−03 | −1.829E−03 |
| D | −3.336E−06 | 4.776E−05 | 5.289E−06 | 2.364E−03 | 3.847E−03 | 1.356E−03 |
| E | 7.425E−07 | −6.595E−06 | −4.398E−06 | −8.648E−04 | −1.360E−03 | −5.779E−04 |
| F | −8.396E−08 | 6.070E−07 | 1.252E−06 | 2.035E−04 | 3.141E−04 | 1.571E−04 |
| G | 5.202E−09 | −4.475E−08 | −1.984E−07 | −3.192E−05 | −4.881E−05 | −2.849E−05 |
| H | −1.685E−10 | 3.160E−09 | 1.937E−08 | 3.381E−06 | 5.147E−06 | 3.495E−06 |
| J | 2.224E−12 | −1.944E−10 | −1.184E−09 | −2.389E−07 | −3.634E−07 | −2.867E−07 |
| L | 0 | 8.149E−12 | 4.385E−11 | 1.079E−08 | 1.645E−08 | 1.509E−08 |
| M | 0 | −1.897E−13 | −8.893E−13 | −2.818E−10 | −4.314E−10 | −4.611E−10 |
| N | 0 | 1.806E−15 | 7.426E−15 | 3.234E−12 | 4.983E−12 | 6.235E−12 |
| O | 0 | 0 | 0 | 0 | 0 | 0 |
| P | 0 | 0 | 0 | 0 | 0 | 0 |

| Surface | | | | | | |
|---|---|---|---|---|---|---|
| No. | S7 | S8 | S9 | S10 | S11 | S12 |
| K | −2.285E−01 | 6.707E−03 | −1.780E+00 | −1.905E−01 | 4.192E−01 | −1.445E+00 |
| A | 5.262E−04 | 6.508E−03 | 2.962E−03 | −6.318E−03 | −1.490E−02 | −1.513E−02 |
| B | −9.947E−04 | −1.469E−02 | −8.287E−03 | 2.143E−02 | −5.640E−03 | −2.036E−03 |
| C | −3.517E−05 | 1.502E−02 | 6.469E−03 | −4.304E−02 | 1.192E−02 | 5.082E−03 |
| D | 7.757E−04 | −8.478E−03 | −6.469E−04 | 5.610E−02 | −1.337E−02 | −5.313E−03 |
| E | −6.584E−04 | 2.589E−03 | −2.344E−03 | −4.875E−02 | 9.372E−03 | 3.326E−03 |
| F | 2.893E−04 | −2.403E−04 | 1.958E−03 | 2.920E−02 | −4.337E−03 | −1.330E−03 |
| G | −7.918E−05 | −1.197E−04 | −8.150E−04 | −1.221E−02 | 1.356E−03 | 3.488E−04 |
| H | 1.423E−05 | 5.350E−05 | 2.076E−04 | 3.553E−03 | −2.850E−04 | −5.984E−05 |
| J | −1.685E−06 | −1.041E−05 | −3.367E−05 | −7.051E−04 | 3.874E−05 | 6.491E−06 |
| L | 1.269E−07 | 1.132E−06 | 3.403E−06 | 9.091E−05 | −3.082E−06 | −4.053E−07 |
| M | −5.525E−09 | −6.687E−08 | −1.960E−07 | −6.860E−06 | 1.089E−07 | 1.114E−08 |
| N | 1.060E−10 | 1.679E−09 | 4.914E−09 | 2.299E−07 | 0 | 0 |
| O | 0 | 0 | 0 | 0 | 0 | 0 |
| P | 0 | 0 | 0 | 0 | 0 | 0 |

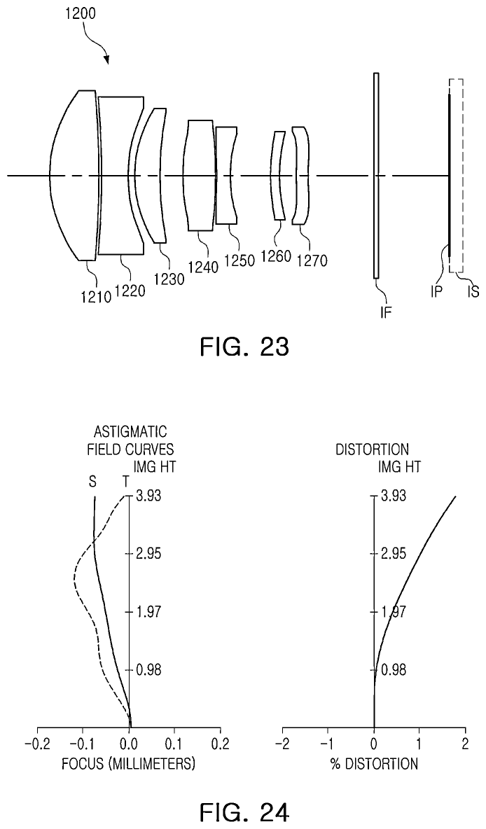

An imaging lens system 1200 according to a twelfth example of the one or more embodiments will be described with reference to FIG. 23.

The imaging lens system 1200 may include a plurality of lens groups. For example, the imaging lens system 1200 may include a first lens 1210, a second lens 1220, a third lens 1230, a fourth lens 1240, a fifth lens 1250, a sixth lens 1260, and a seventh lens 1270, sequentially arranged from an object side toward an imaging plane.

The first lens 1210 may have positive refractive power, and may have a convex object-side surface and a convex image-side surface. The second lens 1220 may have negative refractive power, and may have a concave object-side surface and a concave image-side surface. The third lens 1230 may have positive refractive power, and may have a convex object-side surface and a concave image-side surface. The fourth lens 1240 may have positive refractive power, and may have a convex object-side surface and a convex image-side surface. The fifth lens 1250 may have negative refractive power, and may have a concave object-side surface and a concave image-side surface. The sixth lens 1260 may have negative refractive power, and may have a convex object-side surface and a concave image-side surface. The seventh lens 1270 may have negative refractive power, and may have a convex object-side surface and a concave image-side surface.

The imaging lens system 1200 may further include a filter IF and an imaging plane IP. The imaging plane IP may be formed on an image sensor IS, and the filter IF may be disposed between the seventh lens 1270 and the imaging plane IP.

The imaging lens system 1200 configured as above exhibits aberration characteristics as illustrated in FIG. 24. Tables 23 and 24 below illustrate lens characteristics and aspherical values of the imaging lens system according to the present embodiment.

TABLE 23

| Surface | | Curvature | Thickness/ | Refractive | Abbe | Effective | Effective |
|---|---|---|---|---|---|---|---|
| No. | Component | Radius | Distance | Index | No. | Radius | Radius |
| S1 | 1st Lens | 6.4936 | 2.3000 | 1.535 | 55.70 | 4.150 | 3.200 |
| S2 | | −42.0297 | 0.1333 | | | 3.950 | 3.200 |
| S3 | 2nd Lens | −91.9566 | 1.1865 | 1.614 | 25.90 | 3.875 | 3.200 |
| S4 | | 6.0258 | 0.3000 | | | 3.389 | 3.200 |
| S5 | 3rd Lens | 5.9086 | 1.2155 | 1.535 | 55.70 | 3.284 | 3.200 |
| S6 | | 19.6968 | 1.0262 | | | 3.116 | 3.116 |
| S7 | 4th Lens | 9.1995 | 1.5000 | 1.671 | 19.20 | 2.692 | 2.692 |
| S8 | | −34.3816 | 0.0894 | | | 2.455 | 2.455 |
| S9 | 5th Lens | −16.8659 | 0.5898 | 1.614 | 25.90 | 2.384 | 2.384 |
| S10 | | 8.5107 | 1.8774 | | | 2.080 | 2.080 |
| S11 | 6th Lens | 10.9279 | 0.4000 | 1.544 | 56.00 | 2.159 | 2.159 |
| S12 | | 8.9440 | 0.7741 | | | 2.151 | 2.151 |
| S13 | 7th Lens | 12.11 | 0.5282 | 1.544 | 56.00 | 2.200 | 2.200 |
| S14 | | 8.59 | 3.0000 | | | 2.377 | 2.377 |
| S15 | Filter | Infinity | 0.2100 | 1.518 | 64.17 | 5.000 | 5.000 |
| S16 | | Infinity | 3.2725 | | | 5.000 | 5.000 |
| S17 | Imaging | Infinity | −0.0030 | | | 3.932 | 3.932 |
| | plane | | | | | | |

TABLE 24

| Surface | | | | | | | |
|---|---|---|---|---|---|---|---|
| No. | S1 | S2 | S3 | S4 | S5 | S6 | S7 |
| K | −0.59452036 | 0 | 0 | −1.22914571 | −0.10554954 | 26.83016552 | −0.51950343 |
| A | 1.91663E−05 | 0.000167659 | −0.00060703 | −0.00141051 | −0.00053712 | 0.000967043 | 0.002825094 |
| B | 1.35754E−07 | 3.21019E−06 | 2.87537E−05 | −8.4569E−06 | −0.00041092 | −0.00240835 | −0.00351233 |
| C | −6.0303E−07 | −2.5738E−07 | −9.7807E−07 | −7.2212E−07 | 0.000132485 | 0.001139979 | 0.00156532 |
| D | 5.93727E−08 | −1.7536E−08 | 2.62737E−08 | −1.1406E−07 | −8.6251E−06 | −0.00029631 | −0.00041477 |
| E | −2.0441E−09 | −1.0299E−09 | −3.2237E−09 | 8.44837E−09 | −3.4609E−06 | 4.63754E−05 | 4.97249E−05 |
| F | −8.5172E−11 | 0 | 4.98321E−11 | 1.61891E−09 | 9.09828E−07 | −4.345E−06 | 1.0684E−06 |
| G | 1.40688E−12 | 0 | 3.67466E−12 | −1.3963E−11 | −9.4938E−08 | 2.3038E−07 | −9.7405E−07 |
| H | 4.1722E−13 | 0 | −2.5962E−13 | −8.9389E−12 | 4.77131E−09 | −6.0004E−09 | 9.87716E−08 |
| J | −1.4282E−14 | 0 | 0 | 0 | −9.6666E−11 | 4.91864E−11 | −3.3066E−09 |
| L | 0 | 0 | 0 | 0 | 0 | 0 | 0 |
| M | 0 | 0 | 0 | 0 | 0 | 0 | 0 |
| N | 0 | 0 | 0 | 0 | 0 | 0 | 0 |
| O | 0 | 0 | 0 | 0 | 0 | 0 | 0 |
| P | 0 | 0 | 0 | 0 | 0 | 0 | 0 |
| Surface | | | | | | | |
| No. | S8 | S9 | S10 | S11 | S12 | S13 | S14 |
| K | 0.757637992 | 0.280450149 | −0.13561362 | −9.15426381 | −1.52262612 | 9.295502877 | −8.60681264 |
| A | 0.009832533 | −0.00140838 | −0.01191453 | −0.00013234 | 0.000199451 | −0.01941427 | −0.01950558 |
| B | −0.01810964 | −0.00364484 | 0.018107758 | −2.8136E−05 | 7.31168E−05 | −0.00778794 | 0.000540441 |
| C | 0.017282713 | 0.008516274 | −0.01491816 | −3.3178E−06 | 1.23949E−05 | 0.016099148 | 0.002007453 |
| D | −0.00961889 | −0.00588386 | 0.008701025 | −1.5902E−06 | 3.54706E−06 | −0.01774731 | −0.00248267 |
| E | 0.003187354 | 0.002097361 | −0.00341696 | 1.69454E−16 | 1.65805E−16 | 0.012665179 | 0.001801514 |
| F | −0.00063704 | −0.00042032 | 0.000884261 | 6.65447E−18 | 6.50622E−18 | −0.00600872 | −0.00083358 |
| G | 7.53234E−05 | 4.69889E−05 | −0.00014463 | 2.63789E−19 | 2.63011E−19 | 0.001910076 | 0.000250795 |
| H | −4.8526E−06 | −2.6658E−06 | 1.35228E−05 | 1.04433E−20 | 1.04779E−20 | −0.00040196 | −4.8898E−05 |
| J | 1.31314E−07 | 5.66329E−08 | −5.4946E−07 | 4.17595E−22 | 4.34647E−22 | 5.3721E−05 | 5.96127E−06 |
| L | 0 | 0 | 0 | 0 | 0 | −4.1289E−06 | −4.1313E−07 |
| M | 0 | 0 | 0 | 0 | 0 | 1.38974E−07 | 1.2427E−08 |
| N | 0 | 0 | 0 | 0 | 0 | 0 | 0 |
| O | 0 | 0 | 0 | 0 | 0 | 0 | 0 |
| P | 0 | 0 | 0 | 0 | 0 | 0 | 0 |

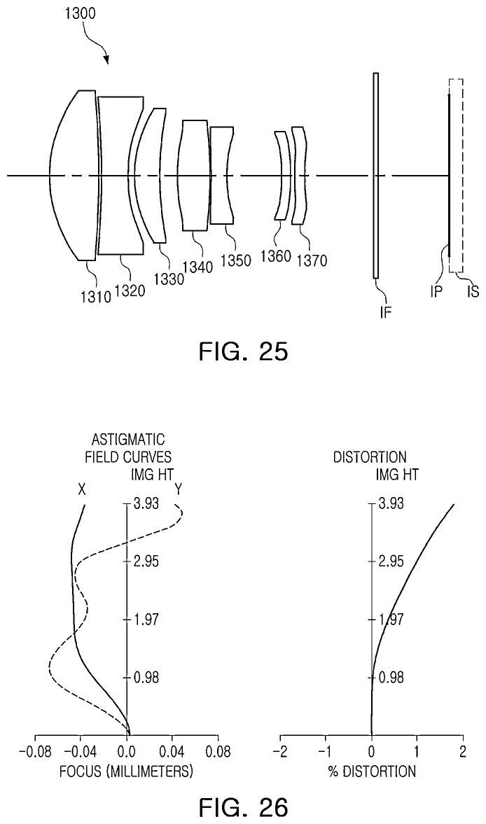

An imaging lens system 1300 according to a thirteenth example of the one or more embodiments will be described with reference to FIG. 25.

The imaging lens system 1300 may include a plurality of lens groups. For example, the imaging lens system 1300 may include a first lens 1310, a second lens 1320, a third lens 1330, a fourth lens 1340, a fifth lens 1350, a sixth lens 1360, and a seventh lens 1370, sequentially arranged from an object side toward an imaging plane.

The first lens 1310 may have positive refractive power, and may have a convex object-side surface and a convex image-side surface. The second lens 1320 may have negative refractive power, and may have a concave object-side surface and a concave image-side surface. The third lens 1330 may have positive refractive power, and may have a convex object-side surface and a concave image-side surface. The fourth lens 1340 may have positive refractive power, and may have a convex object-side surface and a convex image-side surface. The fifth lens 1350 may have negative refractive power, and may have a concave object-side surface and a concave image-side surface. The sixth lens 1360 may have negative refractive power, and may have a convex object-side surface and a concave image-side surface. The seventh lens 1370 may have negative refractive power, and may have a convex object-side surface and a concave image-side surface.

The imaging lens system 1300 may further include a filter IF and an imaging plane IP. The imaging plane IP may be formed on an image sensor IS, and the filter IF may be disposed between the seventh lens 1370 and the imaging plane IP.

The imaging lens system 1300 configured as above exhibits aberration characteristics as illustrated in FIG. 26. Tables 25 and 26 below illustrate lens characteristics and aspherical values of the imaging lens system according to the present example.

TABLE 25

| Surface | | Curvature | Thickness/ | Refractive | Abbe | Effective | Effective |
|---|---|---|---|---|---|---|---|
| No. | Component | Radius | Distance | Index | No. | Radius | Radius |
| S1 | 1st Lens | 6.6620 | 2.2970 | 1.535 | 55.70 | 4.150 | 3.200 |
| S2 | | −32.6341 | 0.1245 | | | 3.952 | 3.200 |
| S3 | 2nd Lens | −60.4258 | 1.1854 | 1.614 | 25.90 | 3.861 | 3.200 |
| S4 | | 6.0659 | 0.2992 | | | 3.325 | 3.200 |
| S5 | 3rd Lens | 5.7731 | 1.2135 | 1.535 | 55.70 | 3.223 | 3.200 |
| S6 | | 19.5316 | 0.7500 | | | 3.071 | 3.071 |
| S7 | 4th Lens | 8.7285 | 1.4990 | 1.671 | 19.20 | 2.713 | 2.713 |
| S8 | | −71.0565 | 0.1068 | | | 2.467 | 2.467 |
| S9 | 5th Lens | −17.1892 | 0.7360 | 1.614 | 25.90 | 2.407 | 2.407 |
| S10 | | 9.7014 | 2.4995 | | | 2.080 | 2.080 |
| S11 | 6th Lens | −8.5253 | 0.4000 | 1.544 | 56.00 | 2.080 | 2.080 |
| S12 | | −9.0366 | 0.2000 | | | 2.164 | 2.164 |
| S13 | 7th Lens | 10.98 | 0.4516 | 1.544 | 56.00 | 2.200 | 2.200 |
| S14 | | 6.82 | 3.0000 | | | 2.346 | 2.346 |
| S15 | Filter | Infinity | 0.2100 | 1.518 | 64.17 | 5.000 | 5.000 |
| S16 | | Infinity | 3.4308 | | | 5.000 | 5.000 |
| S17 | Imaging | Infinity | −0.0030 | | | 3.934 | 3.934 |
| | plane | | | | | | |

TABLE 26

| Surface | | | | | | | |
|---|---|---|---|---|---|---|---|
| No. | S1 | S2 | S3 | S4 | S5 | S6 | S7 |
| K | −0.63535122 | 0 | 0 | −1.29375531 | −0.06849753 | 26.6898043 | −0.27323074 |
| A | −4.4706E−06 | 0.00017008 | −0.00060836 | −0.00144256 | −0.00222805 | −0.00197532 | 0.001341624 |
| B | −7.036E−07 | 2.85686E−06 | 2.86667E−05 | −9.3154E−06 | 0.000865214 | −3.4996E−06 | −0.00191923 |
| C | −6.2276E−07 | −2.8456E−07 | −9.4679E−07 | −6.3897E−07 | −0.00038079 | 0.000191078 | 0.001075715 |
| D | 6.07532E−08 | −1.6854E−08 | 3.1472E−08 | −9.8791E−08 | 0.000127356 | −6.8729E−05 | −0.00042072 |
| E | −1.8737E−09 | −8.1525E−10 | −2.782E−09 | 1.00923E−08 | −2.7346E−05 | 1.18067E−05 | 9.17562E−05 |
| F | −7.677E−11 | 0 | 7.46881E−11 | 1.77642E−09 | 3.68051E−06 | −1.0386E−06 | −1.1177E−05 |
| G | 1.55725E−12 | 0 | 6.38903E−12 | 1.2558E−12 | −3.0079E−07 | 3.99594E−08 | 7.20503E−07 |
| H | 3.86072E−13 | 0 | −1.9463E−13 | −7.2478E−12 | 1.37081E−08 | −1.2184E−10 | −1.9206E−08 |
| J | −2.0707E−14 | 0 | 0 | 0 | −2.7098E−10 | −2.4268E−11 | −1.9056E−12 |
| L | 0 | 0 | 0 | 0 | 0 | 0 | 0 |
| M | 0 | 0 | 0 | 0 | 0 | 0 | 0 |
| N | 0 | 0 | 0 | 0 | 0 | 0 | 0 |
| O | 0 | 0 | 0 | 0 | 0 | 0 | 0 |
| P | 0 | 0 | 0 | 0 | 0 | 0 | 0 |
| Surface | | | | | | | |
| No. | S8 | S9 | S10 | S11 | S12 | S13 | S14 |
| K | 20.00 | 1.727045771 | −0.72368094 | 2.233752629 | −10.00 | 9.486744556 | −8.6480707 |
| A | 0.006616755 | −0.00046192 | −0.00832265 | −0.00091985 | 0.000706432 | −0.01671026 | −0.01841493 |
| B | −0.01235289 | −0.00418775 | 0.01246723 | −0.00024311 | 7.92042E−06 | −0.02159823 | −0.01264957 |
| C | 0.013364183 | 0.008812325 | −0.01084705 | −2.2748E−05 | −3.7598E−05 | 0.037326843 | 0.023394698 |
| D | −0.00826317 | −0.00627206 | 0.006923848 | −8.5273E−06 | −4.592E−06 | −0.03615787 | −0.02174948 |
| E | 0.002941308 | 0.002354735 | −0.00291886 | 2.59739E−16 | 3.00425E−16 | 0.023049149 | 0.013005952 |
| F | −0.00062032 | −0.00050599 | 0.000796893 | 1.24567E−17 | 1.23098E−17 | −0.00997697 | −0.00521226 |
| G | 7.68628E−05 | 6.2401E−05 | −0.00013614 | 5.46065E−19 | 5.45301E−19 | 0.00294777 | 0.001411058 |
| H | −5.1839E−06 | −4.1034E−06 | 1.3226E−05 | 2.40369E−20 | 2.40709E−20 | −0.00058555 | −0.00025453 |
| J | 1.47165E−07 | 1.11145E−07 | −5.5738E−07 | 1.03773E−21 | 1.05471E−21 | 7.4825E−05 | 2.93025E−05 |
| L | 0 | 0 | 0 | 0 | 0 | −5.5587E−06 | −1.9474E−06 |
| M | 0 | 0 | 0 | 0 | 0 | 1.82521E−07 | 5.68455E−08 |
| N | 0 | 0 | 0 | 0 | 0 | 0 | 0 |
| O | 0 | 0 | 0 | 0 | 0 | 0 | 0 |
| P | 0 | 0 | 0 | 0 | 0 | 0 | 0 |

Table 27 shows characteristic values of the imaging lens system according to the first to thirteenth embodiments.

TABLE 27

| Characteristic | 1^{st} | 2^{nd} | 3^{rd} | 4^{th} | 5^{th} | 6^{th} | 7^{th} |
|---|---|---|---|---|---|---|---|
| values | Example | Example | Example | Example | Example | Example | Example |
| f1 | 8.779 | 9.739 | 11.743 | 12.066 | 11.957 | 11.968 | 10.538 |
| f2 | −9.867 | −11.340 | −8.983 | −9.235 | −9.092 | −10.957 | −9.576 |
| f3 | 58.482 | 23.842 | 11.872 | 11.719 | 12.309 | 16.743 | 16.713 |
| f4 | 8.038 | 9.861 | 8.589 | 8.852 | 9.536 | 8.968 | 10.000 |
| f5 | −5.779 | −5.996 | −6.290 | −6.247 | −7.052 | −6.787 | −7.293 |
| f6 | 50.671 | 64.833 | −131.205 | −243.201 | −100.798 | −140.171 | −113.210 |
| f7 | — | — | — | — | — | — | — |
| TTL | 18.450 | 18.450 | 18.300 | 18.300 | 18.400 | 18.400 | 18.400 |
| BFL | 7.548 | 7.324 | 6.849 | 6.777 | 6.362 | 6.851 | 6.600 |
| f | 19.400 | 19.403 | 19.398 | 19.397 | 19.402 | 19.406 | 19.403 |
| f number | 2.337 | 2.337 | 2.337 | 2.337 | 2.337 | 2.337 | 2.337 |
| ImgHT | 3.584 | 3.584 | 3.584 | 3.584 | 3.584 | 3.584 | 3.584 |
| FOV | 20.624 | 20.747 | 20.757 | 20.764 | 20.762 | 20.733 | 20.761 |

| Characteristic | 8^{th} | 9^{th} | 10^{th} | 11^{th} | 12^{th} | 13^{th} |
|---|---|---|---|---|---|---|
| values | Example | Example | Example | Example | Example | Example |
| f1 | 11.215 | 11.067 | 11.350 | 10.975 | 10.690 | 10.556 |
| f2 | −9.652 | −10.457 | −10.972 | −10.732 | −9.168 | −8.918 |
| f3 | 14.647 | 16.183 | 16.154 | 16.990 | 15.307 | 14.862 |
| f4 | 9.683 | 10.672 | 11.311 | 10.393 | 10.968 | 11.673 |
| f5 | −7.069 | −7.917 | −8.253 | −7.278 | −9.132 | −9.996 |
| f6 | −113.491 | −54.695 | −54.409 | −101.399 | −97.489 | −382.303 |
| f7 | — | — | — | — | −57.416 | −34.375 |
| TTL | 18.400 | 18.400 | 18.400 | 18.401 | 18.400 | 18.400 |
| BFL | 6.547 | 6.502 | 6.550 | 6.480 | 7.782 | 7.289 |
| f | 19.403 | 19.404 | 19.403 | 19.404 | 19.405 | 19.404 |
| f number | 2.337 | 2.337 | 2.337 | 2.337 | 2.512 | 2.576 |
| ImgHT | 3.584 | 3.584 | 3.584 | 3.584 | 3.584 | 3.584 |
| FOV | 20.761 | 20.746 | 20.741 | 20.745 | 20.635 | 20.639 |

Tables 28 to 31 below show conditional expression values of the imaging lens system according to the first to thirteenth embodiments.

TABLE 28

| Conditional | | | | | | | |
|---|---|---|---|---|---|---|---|
| Expression | 1^{st} | 2^{nd} | 3^{rd} | 4^{th} | 5^{th} | 6^{th} | 7^{th} |
| Values | Example | Example | Example | Example | Example | Example | Example |
| AR1 | 0.777 | 0.777 | 0.777 | 0.777 | 0.777 | 0.777 | 0.777 |
| (D12 + D23)/D34 | 0.561 | 0.495 | 0.363 | 0.245 | 0.267 | 0.221 | 0.221 |
| Xc1/SumT | 0.613 | 0.605 | 0.545 | 0.587 | 0.539 | 0.592 | 0.548 |
| TTL/SumT | 2.724 | 2.691 | 2.402 | 2.590 | 2.388 | 2.625 | 2.430 |

| Conditional | | | | | | |
|---|---|---|---|---|---|---|
| Expression | 8^{th} | 9^{th} | 10^{th} | 11^{th} | 12^{th} | 13^{th} |
| Values | Example | Example | Example | Example | Example | Example |
| AR1 | 0.777 | 0.777 | 0.777 | 0.777 | 0.771 | 0.771 |
| (D12 + D23)/D34 | 0.276 | 0.288 | 0.236 | 0.232 | 0.422 | 0.565 |
| Xc1/SumT | 0.594 | 0.547 | 0.566 | 0.542 | 0.538 | 0.533 |
| TTL/SumT | 2.633 | 2.425 | 2.509 | 2.403 | 2.383 | 2.364 |

TABLE 29

| Conditional | | | | | | | |
|---|---|---|---|---|---|---|---|
| Expression | 1^{st} | 2^{nd} | 3^{rd} | 4^{th} | 5^{th} | 6^{th} | 7^{th} |
| Values | Example | Example | Example | Example | Example | Example | Example |
| AR1 | 0.777 | 0.777 | 0.777 | 0.777 | 0.777 | 0.777 | 0.777 |
| AR2 | 0.820 | 0.846 | 0.836 | 0.820 | 0.822 | 0.823 | 0.826 |
| AR3 | 0.946 | 0.944 | 0.976 | 0.956 | 0.962 | 0.936 | 0.950 |
| AR1/AR2 | 1.055 | 1.089 | 1.076 | 1.055 | 1.058 | 1.060 | 1.063 |
| AR1/AR3 | 1.218 | 1.215 | 1.256 | 1.230 | 1.238 | 1.204 | 1.223 |

| Conditional | | | | | | |
|---|---|---|---|---|---|---|
| Expression | 8^{th} | 9^{th} | 10^{th} | 11^{th} | 12^{th} | 13^{th} |
| Values | Example | Example | Example | Example | Example | Example |
| AR1 | 0.777 | 0.777 | 0.777 | 0.777 | 0.771 | 0.771 |
| AR2 | 0.820 | 0.817 | 0.818 | 0.820 | 0.826 | 0.829 |
| AR3 | 0.949 | 0.939 | 0.934 | 0.946 | 0.974 | 0.993 |
| AR1/AR2 | 1.055 | 1.051 | 1.053 | 1.055 | 1.071 | 1.075 |
| AR1/AR3 | 1.222 | 1.208 | 1.202 | 1.218 | 1.264 | 1.288 |

TABLE 30

| Conditional | | | | | | | |
|---|---|---|---|---|---|---|---|
| Expression | 1^{st} | 2^{nd} | 3^{rd} | 4^{th} | 5^{th} | 6^{th} | 7^{th} |
| Values | Example | Example | Example | Example | Example | Example | Example |
| TTL/f | 0.951 | 0.951 | 0.943 | 0.943 | 0.948 | 0.948 | 0.948 |
| TTL/BFL | 2.444 | 2.519 | 2.672 | 2.700 | 2.892 | 2.686 | 2.788 |
| ER1/BFL | 0.550 | 0.567 | 0.606 | 0.612 | 0.652 | 0.606 | 0.629 |
| D56/BFL | 0.357 | 0.406 | 0.301 | 0.384 | 0.472 | 0.361 | 0.358 |
| f/BFL | 2.570 | 2.649 | 2.832 | 2.862 | 3.049 | 2.833 | 2.940 |
| f5/BFL | −0.766 | −0.819 | −0.918 | −0.922 | −1.108 | −0.991 | −1.105 |
| ImgHT/BFL | 0.475 | 0.489 | 0.523 | 0.529 | 0.563 | 0.523 | 0.543 |

| Conditional | | | | | | |
|---|---|---|---|---|---|---|
| Expression | 8^{th} | 9^{th} | 10^{th} | 11^{th} | 12^{th} | 13^{th} |
| Values | Example | Example | Example | Example | Example | Example |
| TTL/f | 0.948 | 0.948 | 0.948 | 0.948 | 0.948 | 0.948 |
| TTL/BFL | 2.811 | 2.830 | 2.809 | 2.840 | 2.364 | 2.524 |
| ER1/BFL | 0.634 | 0.638 | 0.634 | 0.640 | 0.533 | 0.569 |
| D56/BFL | 0.363 | 0.339 | 0.354 | 0.386 | 0.241 | 0.343 |
| f/BFL | 2.964 | 2.984 | 2.962 | 2.994 | 2.494 | 2.662 |
| f5/BFL | −1.080 | −1.218 | −1.260 | −1.123 | −1.173 | −1.371 |
| ImgHT/BFL | 0.547 | 0.551 | 0.547 | 0.553 | 0.461 | 0.492 |

TABLE 31

| Conditional | | | | | | | |
|---|---|---|---|---|---|---|---|
| Expression | 1^{st} | 2^{nd} | 3^{rd} | 4^{th} | 5^{th} | 6^{th} | 7^{th} |
| Values | Embodiment | Embodiment | Embodiment | Embodiment | Embodiment | Embodiment | Embodiment |
| f1/f4 | 1.092 | 0.988 | 1.367 | 1.363 | 1.254 | 1.335 | 1.054 |
| f2/f3 | −0.169 | −0.476 | −0.757 | −0.788 | −0.739 | −0.654 | −0.573 |
| f4/f5 | −1.391 | −1.645 | −1.366 | −1.417 | −1.352 | −1.321 | −1.371 |
| (f2 + f3)/ | 21.522 | 3.234 | 1.256 | 0.954 | 1.295 | 2.653 | 2.636 |
| (f4 + f5) | | | | | | | |
| R1/R10 | 1.330 | 1.321 | 0.847 | 0.964 | 0.822 | 0.929 | 0.898 |
| (R1 + R4)/ | 0.817 | 0.825 | 0.838 | 0.911 | 0.872 | 0.932 | 0.918 |
| (R5 + R10) | | | | | | | |
| T1/(T2 + T3) | 1.319 | 1.128 | 0.895 | 0.876 | 0.886 | 0.976 | 1.029 |
| T4/(T5 + T6) | 1.554 | 1.135 | 0.755 | 0.772 | 0.903 | 0.796 | 1.120 |

| Conditional | | | | | | |
|---|---|---|---|---|---|---|
| Expression | 8^{th} | 9^{th} | 10^{th} | 11^{th} | 12^{th} | 13^{th} |
| Values | Example | Example | Example | Example | Example | Example |
| f1/f4 | 1.158 | 1.037 | 1.003 | 1.056 | 0.975 | 0.904 |
| f2/f3 | −0.659 | −0.646 | −0.679 | −0.632 | −0.599 | −0.600 |
| f4/f5 | −1.370 | −1.348 | −1.370 | −1.428 | −1.201 | −1.168 |
| (f2 + f3)/ | 1.910 | 2.078 | 1.695 | 2.009 | 3.343 | 3.544 |
| (f4 + f5) | | | | | | |
| R1/R10 | 1.143 | 0.892 | 1.014 | 1.098 | 0.763 | 0.687 |
| (R1 + R4)/ | 1.093 | 1.003 | 1.060 | 1.126 | 0.868 | 0.823 |
| (R5 + R10) | | | | | | |
| T1/(T2 + T3) | 0.923 | 0.904 | 0.914 | 0.923 | 0.958 | 0.958 |
| T4/(T5 + T6) | 0.732 | 1.111 | 1.001 | 1.097 | 1.515 | 1.320 |

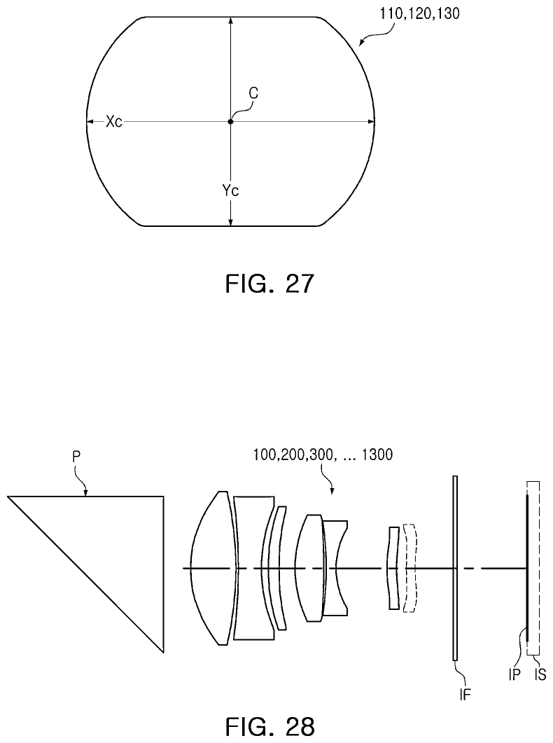

In the imaging lens system according to the first to thirteenth examples, the lens may include a lens in which an effective radius (Xc) in a first direction, intersecting the optical axis (C), is different from an effective radius (Yc) in a second direction, intersecting the optical axis (C). For example, in the imaging lens system 100 according to the first example, the first lens 110 to the third lens 130 may be formed such that an effective radius (Xc) in a first direction, intersecting the optical axis (C), is greater than an effective radius (Yc) in a second direction, intersecting the optical axis (C), as illustrated in FIG. 27.

The imaging lens systems 100, 200, 300, 400, 500, 600, 700, 800, 900, 1000, 1100, 1200, and 1300 according to the first to thirteenth examples are configured to be easily mounted on a portable terminal and a small electronic device. For example, the imaging lens systems 100, 200, 300, 400, 500, 600, 700, 800, 900, 1000, 1100, 1200, and 1300 according to the first to thirteenth examples may further include an optical path conversion device P, as illustrated in FIG. 28, that may be arranged in a length or width direction of the portable terminal.

According to the one or more examples, an imaging lens system having high magnification and an imaging lens system having a low f number may be implemented.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An imaging lens system, comprising:
a first lens having refractive power;
a second lens having refractive power;
a third lens having a convex object-side surface;
a fourth lens having refractive power;
a fifth lens having refractive power; and
a sixth lens having refractive power,
wherein the first lens to the sixth lens are sequentially arranged from an object side toward an imaging plane, and
wherein the imaging lens system satisfies the following conditional expressions:
TTL/f<1.0, and
0.9<f1/f4<1.4,
where TTL is a distance from an object-side surface of the first lens to the imaging plane, f is a focal length of the imaging lens system, f1 is a focal length of the first lens, and f4 is a focal length of the fourth lens.

2. The imaging lens system of claim 1, wherein the first lens has a convex object-side surface.

3. The imaging lens system of claim 1, wherein the second lens has a concave image-side surface.

4. The imaging lens system of claim 1, wherein the fourth lens has a convex object-side surface.

5. The imaging lens system of claim 1, wherein the fifth lens has a concave object-side surface.

6. The imaging lens system of claim 1, wherein the following conditional expression is satisfied:
$$2. < TTL / BFL < 3. ,$$
where BFL is a distance from an image-side surface of a rearmost lens disposed closest to the imaging plane, to the imaging plane.

7. The imaging lens system of claim 1, wherein the following conditional expression is satisfied:
$$0.42 < ImgHT / BFL < 0.60 ,$$
where ImgHT is a height of the imaging plane, and BFL is a distance from an image-side surface of a rearmost lens disposed closest to the imaging plane, to the imaging plane.

8. An imaging lens system, comprising:
a first lens having refractive power;
a second lens having refractive power;
a third lens having refractive power;
a fourth lens having a convex image-side surface;
a fifth lens having a concave object-side surface; and
a sixth lens having refractive power,
wherein the first lens to the sixth lens are sequentially arranged from an object side toward an imaging plane,
wherein one or more of the first lens to the sixth lens are formed such that an effective radius (Xc) in a first direction, intersecting an optical axis, is different from an effective radius (Yc) in a second direction, intersecting the optical axis, and
wherein the imaging lens system satisfies the following conditional expression:
$$TTL / f < 1. ,$$
where TTL is a distance from an object-side surface of the first lens to the imaging plane, and f is a focal length of the imaging lens system.

9. The imaging lens system of claim 8, wherein the first lens has a convex object-side surface.

10. The imaging lens system of claim 8, wherein the second lens has a concave image-side surface.

11. The imaging lens system of claim 8, wherein the third lens has a convex object-side surface.

12. The imaging lens system of claim 8, wherein the sixth lens has a convex object-side surface.

13. The imaging lens system of claim 8, wherein the following conditional expression is satisfied:
0.5<AR1<1.0,
where AR1 is a ratio (Yc1/Xc1) of an effective radius (Yc1) in a short axis direction (the second direction) of the first lens and an effective radius (Xc1) in a long axis direction (the first direction) of the first lens.

14. The imaging lens system of claim 8, wherein the following conditional expression is satisfied:
$$0 < ( D 12 + D 23 ) / D 34 < 0.5 ,$$
where D12 is a distance from an image-side surface of the first lens to an object-side surface of the second lens, D23 is a distance from an image-side surface of the second lens to an object-side surface of the third lens, and D34 is a distance from an image-side surface of the third lens to an object-side surface of the fourth lens.

15. The imaging lens system of claim 8, wherein the following conditional expression is satisfied:
$$0.3 < Xc 1 / SumT < 0.8 ,$$
where Xc1 is an effective radius in a long axis direction (the first direction) of the first lens, and SumT is a sum of thicknesses of all lenses disposed between an object and the imaging plane.

16. The imaging lens system of claim 8, wherein the following conditional expression is satisfied:
$$2. < TTL / SumT ) < 3. ,$$
where SumT is a sum of thicknesses of all lenses disposed between an object and the imaging plane.

17. An imaging lens system, comprising:
a first lens having refractive power;
a second lens having refractive power;
a third lens having a convex object-side surface;
a fourth lens having refractive power;
a fifth lens having refractive power; and
a sixth lens having refractive power,
wherein the first lens to the sixth lens are sequentially arranged from an object side toward an imaging plane, and
wherein the imaging lens system satisfies the following conditional expression:
$$0.2 < D 56 / BFL < 0.50 ,$$
where D56 is a distance from an image-side surface of the fifth lens to an object-side surface of the sixth lens and BFL is a distance from an image-side surface of the sixth lens to the imaging plane.

18. The imaging lens system of claim 17, further comprising a seventh lens disposed on an image side of the sixth lens.

19. The imaging lens system of claim 18, wherein the seventh lens has a convex object-side surface in a paraxial region, and a concave image-side surface in a paraxial region.
